(19) United States
(12) Patent Application Publication
(10) Pub. No.: US 2025/0039942 A1
(43) Pub. Date: Jan. 30, 2025

(54) METHOD AND APPARATUS FOR RANDOM ACCESS REPORT IN A WIRELESS COMMUNICATION SYSTEM

(71) Applicant: ASUS Technology Licensing Inc., Taipei City (TW)

(72) Inventors: Yi-Hsuan Kung, Taipei City (TW); Yu-Hsuan Guo, Taipei City (TW)

(21) Appl. No.: 18/783,290

(22) Filed: Jul. 24, 2024

Related U.S. Application Data
(60) Provisional application No. 63/529,648, filed on Jul. 28, 2023.
(60) Provisional application No. 63/536,655, filed on Sep. 5, 2023.

(51) Int. Cl. H04W 74/0833; H04W 72/23

(52) U.S. Cl. CPC H04W 74/0833; H04W 72/23

(57) ABSTRACT

Methods, systems, and apparatuses are provided for handling random access reporting in a wireless communication system, wherein a method of a User Equipment (UE) comprises receiving a first Physical Downlink Control Channel (PDCCH) order, initiating, in response to receiving the first PDCCH order, a first Random Access (RA) procedure to a candidate cell for early Timing Advance (TA) acquisition, storing a first RA information associated with the first RA procedure, and reporting the first RA information to a network in response to a request from the network.

### CROSS-REFERENCE TO RELATED APPLICATIONS

The present Application claims priority to and the benefit of U.S. Provisional Patent Application Ser. No. 63/529,648, filed Jul. 28, 2023, and U.S. Provisional Patent Application No. 63/536,655, filed Sep. 5, 2023; with each of the referenced applications and disclosures fully incorporated herein by reference.

### FIELD

This disclosure generally relates to wireless communication networks and, more particularly, to a method and apparatus for handling random access reporting in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

The present invention provides methods, systems, and apparatuses for handling random access reporting in a wireless communication system. Embodiments provide reporting for random access procedures for candidate cells associated with L1/L2-Triggered Mobility (LTM) and/or reporting for a random access procedure for cells associated with inter-Cell multi-Transmission/Reception Point (TRP).

In various embodiments, a method of a User Equipment (UE) comprises receiving a first Physical Downlink Control Channel (PDCCH) order, initiating, in response to receiving the first PDCCH order, a first Random Access (RA) procedure to a candidate cell for early Timing Advance (TA) acquisition, storing a first RA information associated with the first RA procedure, and reporting the first RA information to a network in response to a request from the network.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of Figure 6.1.3.4-1: Timing Advance Command MAC CE, from 3GPP 38.321 v17.4.0.

FIG. 6 is a reproduction of Figure x: Signaling procedure for LTM, from R2-2213332 38.300.

FIG. 7 is a reproduction of Figure 4.3.1-1: Uplink-downlink timing relation, from 3GPP 38.211 v17.1.0.

FIG. 8 an example diagram showing, for a RACH-based LTM, that the UE initiates/performs a random access procedure to a target Cell in an LTM procedure, in accordance with embodiments of the present invention.

FIG. 9 an example diagram showing that the type of the random access procedure could be a (LTM) random access procedure to the candidate cell initiated by a UE, in accordance with embodiments of the present invention.

FIG. 10 is a flow diagram of a method of a UE comprising initiating an RA procedure to a candidate cell, and in response to completion of the RA procedure, determining whether to include or how to set a value of a parameter in an RA information based on at least the type of the RA procedure, in accordance with embodiments of the present invention.

FIG. 11 is a flow diagram of a method of a UE comprising initiating an RA procedure to a non-serving cell, and in response to completion of the RA procedure, determining whether to include or how to set a value of a parameter in an RA information based on at least the type of the RA procedure, in accordance with embodiments of the present invention.

FIG. 12 is a flow diagram of a method of a UE comprising receiving a first PDCCH order, initiating, in response to receiving the first PDCCH order, a first RA procedure to a candidate cell for early TA acquisition, storing a first RA information associated with the first RA procedure, and reporting the first RA information to a network in response to a request from the network, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP 38.321 v17.4.0; [2] 3GPP 38.331 v17.4.0; [3] RP-212710 New WID on NR further mobility enhancements; [4] R2-2213332 38.300 running CR for introduction of NR further mobility enhancements; [5] 3GPP RAN1 #110b report; [6] 3GPP RAN1 #112 report; [7] 3GPP RAN2 #121b is report; [8] 3GPP RAN2 #122 report; [9] RP-223276 WID Update: MIMO Evolution for Downlink and Uplink; [10] 3GPP 38.211 v17.1.0; and [11] R2-2308972 Report from NR MIMO evolution session. The standards and documents listed above are hereby expressly and fully incorporated herein by reference in their entirety.

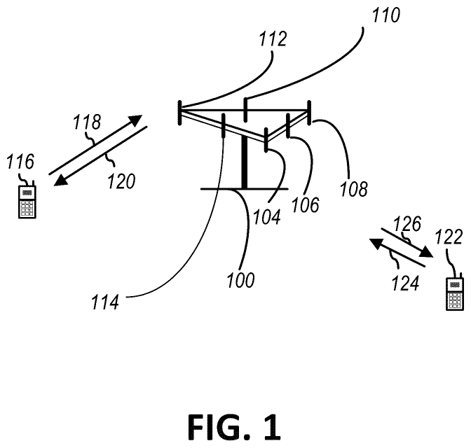

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

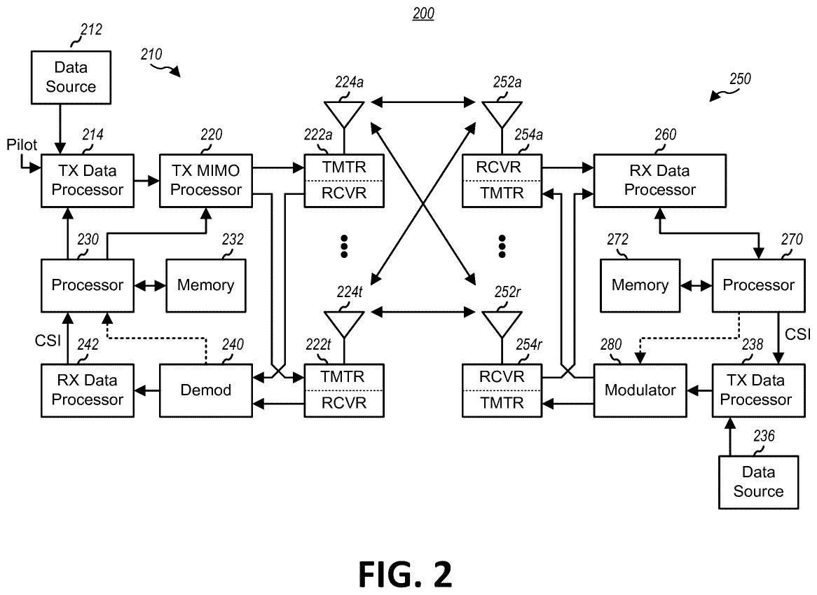

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

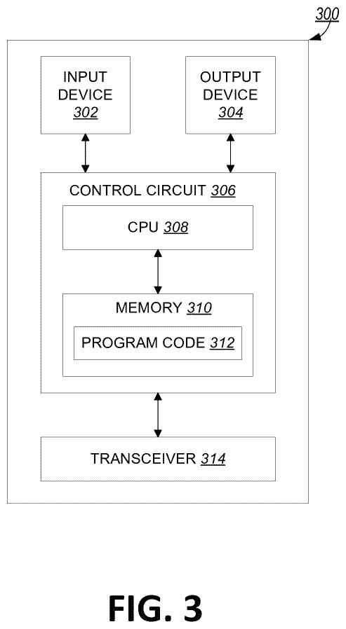

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

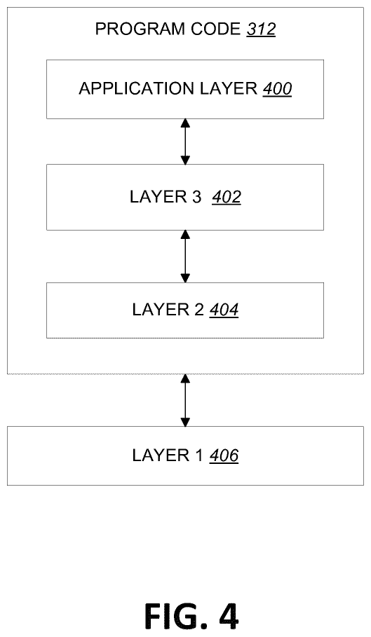

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In 38.321 ([1] 3GPP 38.321 v17.4.0), random access procedure and TA maintenance are introduced:

### 5.1 Random Access Procedure

### 5.1.1 Random Access Procedure Initialization

The Random Access procedure described in this clause is initiated by a PDCCH order, by the MAC entity itself, or by RRC for the events in accordance with TS 38.300 [2]. There is only one Random Access procedure ongoing at any point in time in a MAC entity. The Random Access procedure on an SCell shall only be initiated by a PDCCH order with ra-PreambleIndex different from 0b000000.
[ . . . ]

When a Random Access procedure is initiated, UE selects a set of Random Access resources as specified in clause 5.1.1b and initialises the following parameters for the Random Access procedure according to the values configured by RRC for the selected set of Random Access resources:
prach-ConfigurationIndex: the available set of PRACH occasions for the transmission of the Random Access Preamble for Msg1. These are also applicable to the MSGA PRACH if the PRACH occasions are shared between 2-step and 4-step RA types;
prach-ConfigurationPeriodScaling-IAB: the scaling factor defined in TS 38.211 [8] and applicable to IAB-MTs, extending the periodicity of the PRACH occasions baseline configuration indicated by prach-ConfigurationIndex;
prach-ConfigurationFrameOffset-IAB: the frame offset defined in TS 38.211 [8] and applicable to IAB-MTs, altering the ROs frame defined in the baseline configuration indicated by prach-ConfigurationIndex;
prach-ConfigurationSOffset-IAB: the subframe/slot offset defined in TS 38.211 [8] and applicable to IAB-MTs, altering the ROs subframe or slot defined in the baseline configuration indicated by prach-ConfigurationIndex;
msgA-PRACH-ConfigurationIndex: the available set of PRACH occasions for the transmission of the Random Access Preamble for MSGA in 2-step RA type;
preambleReceivedTargetPower: initial Random Access Preamble power for 4-step RA type;
msgA-PreambleReceivedTargetPower: initial Random Access Preamble power for 2-step RA type;
rsrp-ThresholdSSB: an RSRP threshold for the selection of the SSB for 4-step RA type. If the Random Access procedure is initiated for beam failure recovery, rsrp-ThresholdSSB used for the selection of the SSB within candidateBeamRSList refers to rsrp-ThresholdSSB in BeamFailureRecoveryConfig IE;
rsrp-ThresholdCSI-RS: an RSRP threshold for the selection of CSI-RS for 4-step RA type. If the Random Access procedure is initiated for beam failure recovery, rsrp-ThresholdCSI-RS is equal to rsrp-ThresholdSSB in BeamFailureRecoveryConfig IE;
msgA-RSRP-ThresholdSSB: an RSRP threshold for the selection of the SSB for 2-step RA type;
rsrp-ThresholdSSB-SUL: an RSRP threshold for the selection between the NUL carrier and the SUL carrier;
msgA-RSRP-Threshold: an RSRP threshold for selection between 2-step RA type and 4-step RA type when both 2-step and 4-step RA type Random Access Resources are configured in the UL BWP;
rsrp-ThresholdMsg3: an RSRP threshold for MSG3 repetition (see clause 5.1.1b);
featurePriorities: priorities for features, such as RedCap, NSAG(s), etc. (see clause 5.1.1d);
msgA-TransMax: The maximum number of MSGA transmissions when both 4-step and 2-step RA type Random Access Resources are configured;
candidateBeamRSList: a list of reference signals (CSI-RS and/or SSB) identifying the candidate beams for recovery and the associated Random Access parameters;
recoverySearchSpaceId: the search space identity for monitoring the response of the beam failure recovery request;
powerRampingStep: the power-ramping factor;
msgA-PreamblePowerRampingStep: the power ramping factor for MSGA preamble;
powerRampingStepHighPriority: the power-ramping factor in case of prioritized Random Access procedure;
scalingFactorBI: a scaling factor for prioritized Random Access procedure;
ra-PreambleIndex: Random Access Preamble;
ra-ssb-OccasionMaskIndex: defines PRACH occasion(s) associated with an SSB in which the MAC entity may transmit a Random Access Preamble (see clause 7.4);
msgA-SSB-SharedRO-MaskIndex: Indicates the subset of 4-step RA type PRACH occasions shared with 2-step RA type PRACH occasions for each SSB. If 2-step RA type PRACH occasions are shared with 4-step RA type PRACH occasions and msgA-SSB-SharedRO-MaskIndex is not configured, then all 4-step RA type PRACH occasions are available for 2-step RA type (see clause 7.4);
ra-OccasionList: defines PRACH occasion(s) associated with a CSI-RS in which the MAC entity may transmit a Random Access Preamble;
ra-PreambleStartIndex: the starting index of Random Access Preamble(s) for on-demand SI request;
startPreambleForThisPartition: the first preamble associated with the set of Random Access Resources applicable to the Random Access procedure;
preambleTransMax: the maximum number of Random Access Preamble transmission;
ssb-perRACH-OccasionAndCB-PreamblesPerSSB: defines the number of SSBs mapped to each PRACH occasion for 4-step RA type and the number of contention-based Random Access Preambles mapped to each SSB;
msgA-CB-PreamblesPerSSB-PerSharedRO: defines the number of contention-based Random Access Preambles for 2-step RA type mapped to each SSB when the PRACH occasions are shared between 2-step and 4-step RA types;
msgA-SSB-PerRACH-OccasionAndCB-PreamblesPerSSB: defines the number of SSBs mapped to each PRACH occasion for 2-step RA type and the number of contention-based Random Access Preambles mapped to each SSB;
numberOfPreamblesForThisPartition: the number of consecutive preambles associated with the set of Random Access Resources applicable to the Random Access procedure;
msgA-PUSCH-ResourceGroupA: defines MSGA PUSCH resources that the UE shall use when performing MSGA transmission using Random Access Preambles group A;
msgA-PUSCH-ResourceGroupB: defines MSGA PUSCH resources that the UE shall use when performing MSGA transmission using Random Access Preambles group B;
msgA-PUSCH-Resource-Index: identifies the index of the PUSCH resource used for MSGA in case of contention-free Random Access with 2-step RA type;
[ . . . ]
the set of Random Access Preambles and/or PRACH occasions for SI request, if any;
the set of Random Access Preambles and/or PRACH occasions for beam failure recovery request, if any;
the set of Random Access Preambles and/or PRACH occasions for reconfiguration with sync, if any;
ra-ResponseWindow: the time window to monitor RA response(s) (SpCell only);
ra-ContentionResolutionTimer: the Contention Resolution Timer (SpCell only);
msgB-ResponseWindow: the time window to monitor RA response(s) for 2-step RA type (SpCell only).
[ . . . ]

When the Random Access procedure is initiated on a Serving Cell, the MAC entity shall:
1>flush the Msg3 buffer;
1>flush the MSGA buffer;
1>set the PREAMBLE_TRANSMISSION_COUNTER to 1;
1>set the PREAMBLE_POWER_RAMPING_COUNTER to 1;
1>set the PREAMBLE_BACKOFF to 0 ms;
1>set POWER_OFFSET_2STEP_RA to 0 dB;
1>if the carrier to use for the Random Access procedure is explicitly signalled:
   2>select the signalled carrier for performing Random Access procedure;
   2>set the PCMAX to P_{CMAX,f,c} of the signalled carrier.
1>else if the carrier to use for the Random Access procedure is not explicitly signalled; and
1>if the Serving Cell for the Random Access procedure is configured with supplementary uplink as specified in TS 38.331 [5]; and
1>if the RSRP of the downlink pathloss reference is less than rsrp-ThresholdSSB-SUL:
   2>select the SUL carrier for performing Random Access procedure;
   2>set the PCMAX to P_{CMAX,f,c} of the SUL carrier.
1>else:
   2>select the NUL carrier for performing Random Access procedure;
   2>set the PCMAX to P_{CMAX,f,c} of the NUL carrier.
1>perform the BWP operation as specified in clause 5.15;
1>select the set of Random Access resources applicable to the current Random Access procedure according to clause 5.1.1b;
1>if the Random Access procedure is initiated by PDCCH order and if the ra-PreambleIndex explicitly provided by PDCCH is not 0b000000; or
1>if the Random Access procedure was initiated for SI request (as specified in TS 38.331 [5]) and the Random Access Resources for SI request have been explicitly provided by RRC; or
1>if the Random Access procedure was initiated for SpCell beam failure recovery (as specified in clause 5.17) and if the contention-free Random Access Resources for beam failure recovery request for 4-step RA type have been explicitly provided by RRC for the BWP selected for Random Access procedure; or
1>if the Random Access procedure was initiated for reconfiguration with sync and if the contention-free Random Access Resources for 4-step RA type have been explicitly provided in rach-ConfigDedicated for the BWP selected for Random Access procedure:
   2>set the RA_TYPE to 4-stepRA.
1>else if the BWP selected for Random Access procedure is configured with both 2-step and 4-step RA type Random Access Resources within the selected set of Random Access resources (as specified in clause 5.1.1b) and the RSRP of the downlink pathloss reference is above msgA-RSRP-Threshold; or
1>if the BWP selected for Random Access procedure is only configured with 2-step RA type Random Access resources within the selected set of Random Access resources according to clause 5.1.1b; or
1>if the Random Access procedure was initiated for reconfiguration with sync and if the contention-free Random Access Resources for 2-step RA type have been explicitly provided in rach-ConfigDedicated for the BWP selected for Random Access procedure:
   2>set the RA_TYPE to 2-stepRA.
1>else:
   2>set the RA_TYPE to 4-stepRA.
1>perform initialization of variables specific to Random Access type as specified in clause 5.1.1a;
1>if RA_TYPE is set to 2-stepRA:
   2>perform the Random Access Resource selection procedure for 2-step RA type (see clause 5.1.2a).
1>else:
   2>perform the Random Access Resource selection procedure (see clause 5.1.2).

### 5.1.2 Random Access Resource Selection

If the selected RA_TYPE is set to 4-stepRA, the MAC entity shall:
1>if the Random Access procedure was initiated for SpCell beam failure recovery (as specified in clause 5.17); and
1>if the beamFailureRecoveryTimer (in clause 5.17) is either running or not configured; and
1>if the contention-free Random Access Resources for beam failure recovery request associated with any of the SSBs and/or CSI-RSs have been explicitly provided by RRC; and
1>if at least one of the SSBs with SS-RSRP above rsrp-ThresholdSSB amongst the SSBs in candidateBeamRSList or the CSI-RSs with CSI-RSRP above rsrp-ThresholdCSI-RS amongst the CSI-RSs in candidateBeamRSList is available:
   2>select an SSB with SS-RSRP above rsrp-ThresholdSSB amongst the SSBs in candidateBeamRSList or a CSI-RS with CSI-RSRP above rsrp-ThresholdCSI-RS amongst the CSI-RSs in candidateBeamRSList;
   2>if CSI-RS is selected, and there is no ra-PreambleIndex associated with the selected CSI-RS:
      3>set the PREAMBLE_INDEX to a ra-PreambleIndex corresponding to the SSB in candidateBeamRSList which is quasi-colocated with the selected CSI-RS as specified in TS 38.214 [7].
   2>else:
      3>set the PREAMBLE_INDEX to a ra-PreambleIndex corresponding to the selected SSB or CSI-RS from the set of Random Access Preambles for beam failure recovery request.
1>else if the ra-PreambleIndex has been explicitly provided by PDCCH; and
1>if the ra-PreambleIndex is not 0b000000:
   2>set the PREAMBLE_INDEX to the signalled ra-PreambleIndex;
   2>select the SSB signalled by PDCCH.
1>else if the contention-free Random Access Resources associated with SSBs have been explicitly provided in rach-ConfigDedicated and at least one SSB with SS-RSRP above rsrp-ThresholdSSB amongst the associated SSBs is available:
   2>select an SSB with SS-RSRP above rsrp-ThresholdSSB amongst the associated SSBs;
   2>set the PREAMBLE_INDEX to a ra-PreambleIndex corresponding to the selected SSB.
1>else if the contention-free Random Access Resources associated with CSI-RSs have been explicitly provided in rach-ConfigDedicated and at least one CSI-RS with CSI-RSRP above rsrp-ThresholdCSI-RS amongst the associated CSI-RSs is available:
   2>select a CSI-RS with CSI-RSRP above rsrp-ThresholdCSI-RS amongst the associated CSI-RSs;
   2>set the PREAMBLE_INDEX to a ra-PreambleIndex corresponding to the selected CSI-RS.
1>else if the Random Access procedure was initiated for SI request (as specified in TS 38.331 [5]); and
1>if the Random Access Resources for SI request have been explicitly provided by RRC:
   2>if at least one of the SSBs with SS-RSRP above rsrp-ThresholdSSB is available:
      3>select an SSB with SS-RSRP above rsrp-ThresholdSSB.
   2>else:
      3>select any SSB.
   2>select a Random Access Preamble corresponding to the selected SSB, from the Random Access Preamble(s) determined according to ra-PreambleStartIndex as specified in TS 38.331 [5];
   2>set the PREAMBLE_INDEX to selected Random Access Preamble.
1>else (i.e. for the contention-based Random Access preamble selection):
   2>if at least one of the SSBs with SS-RSRP above rsrp-ThresholdSSB is available:
      3>select an SSB with SS-RSRP above rsrp-ThresholdSSB.
   2>else:
      3>select any SSB.
   2>if the RA_TYPE is switched from 2-stepRA to 4-stepRA:
      3>if a Random Access Preambles group was selected during the current Random Access procedure:
         4>select the same group of Random Access Preambles as was selected for the 2-step RA type.
      3>else:
         4>if Random Access Preambles group B is configured; and
         4>if the transport block size of the MSGA payload configured in the rach-ConfigDedicated corresponds to the transport block size of the MSGA payload associated with Random Access Preambles group B:
         5>select the Random Access Preambles group B.
         4>else:
         5>select the Random Access Preambles group A.
   2>else if Msg3 buffer is empty:
      3>if Random Access Preambles group B is configured:
         4>if the potential Msg3 size (UL data available for transmission plus MAC subheader(s) and, where required, MAC CEs) is greater than ra-Msg3SizeGroupA and the pathloss is less than PCMAX (of the Serving Cell performing the Random Access Procedure)-preambleReceivedTargetPower-msg3-DeltaPreamble-messagePowerOffsetGroupB; or
         4>if the Random Access procedure was initiated for the CCCH logical channel and the CCCH SDU size plus MAC subheader is greater than ra-Msg3SizeGroupA:
         5>select the Random Access Preambles group B.
         4>else:
         5>select the Random Access Preambles group A.
      3>else:
         4>select the Random Access Preambles group A.
   2>else (i.e. Msg3 is being retransmitted):
      3>select the same group of Random Access Preambles as was used for the Random Access Preamble transmission attempt corresponding to the first transmission of Msg3.
   2>select a Random Access Preamble randomly with equal probability from the Random Access Preambles associated with the selected SSB and the selected Random Access Preambles group;
   2>set the PREAMBLE_INDEX to the selected Random Access Preamble.
1>if the Random Access procedure was initiated for SI request (as specified in TS 38.331 [5]); and
1>if ra-AssociationPeriodIndex and si-RequestPeriod are configured:
   2>determine the next available PRACH occasion from the PRACH occasions corresponding to the selected SSB in the association period given by ra-AssociationPeriodIndex in the si-RequestPeriod permitted by the restrictions given by the ra-ssb-OccasionMaskIndex if configured (the MAC entity shall select a PRACH occasion randomly with equal probability amongst the consecutive PRACH occasions according to clause 8.1 of TS 38.213 [6] corresponding to the selected SSB).
1>else if an SSB is selected above:
   2>determine the next available PRACH occasion from the PRACH occasions corresponding to the selected SSB permitted by the restrictions given by the ra-ssb-OccasionMaskIndex if configured, or ssb-SharedRO-MaskIndex if configured, or indicated by PDCCH (the MAC entity shall select a PRACH occasion randomly with equal probability amongst the consecutive PRACH occasions according to clause 8.1 of TS 38.213 [6]regardless the FR2 UL gap, corresponding to the selected SSB; the MAC entity may take into account the possible occurrence of measurement gaps and MUSIM gaps when determining the next available PRACH occasion corresponding to the selected SSB).
1>else if a CSI-RS is selected above:
   2>if there is no contention-free Random Access Resource associated with the selected CSI-RS:
      3>determine the next available PRACH occasion from the PRACH occasions, permitted by the restrictions given by the ra-ssb-OccasionMaskIndex if configured, corresponding to the SSB in candidateBeamRSList which is quasi-colocated with the selected CSI-RS as specified in TS 38.214 [7] (the MAC entity shall select a PRACH occasion randomly with equal probability amongst the consecutive PRACH occasions according to clause 8.1 of TS 38.213 [6] regardless the FR2 UL gap, corresponding to the SSB which is quasi-colocated with the selected CSI-RS; the MAC entity may take into account the possible occurrence of measurement gaps and MUSIM gaps when determining the next available PRACH occasion corresponding to the SSB which is quasi-colocated with the selected CSI-RS).
   2>else:
      3>determine the next available PRACH occasion from the PRACH occasions in ra-OccasionList corresponding to the selected CSI-RS (the MAC entity shall select a PRACH occasion randomly with equal probability amongst the PRACH occasions occurring simultaneously but on different subcarriers regardless the FR2 UL gap, corresponding to the selected CSI-RS; the MAC entity may take into account the possible occurrence of measurement gaps and MUSIM gaps when determining the next available PRACH occasion corresponding to the selected CSI-RS).
1>perform the Random Access Preamble transmission procedure (see clause 5.1.3).
[ . . . ]

### 5.1.3 Random Access Preamble Transmission

The MAC entity shall, for each Random Access Preamble:
1>if PREAMBLE_TRANSMISSION_COUNTER is greater than one; and
1>if the notification of suspending power ramping counter has not been received from lower layers; and
1>if LBT failure indication was not received from lower layers for the last Random Access Preamble transmission; and
1>if SSB or CSI-RS selected is not changed from the selection in the last Random Access Preamble transmission:
   2>increment PREAMBLE_POWER_RAMPING_COUNTER by 1.
1>select the value of DELTA_PREAMBLE according to clause 7.3;
1>set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA;
1>except for contention-free Random Access Preamble for beam failure recovery request, compute the RA-RNTI associated with the PRACH occasion in which the Random Access Preamble is transmitted;
1>instruct the physical layer to transmit the Random Access Preamble using the selected PRACH occasion, corresponding RA-RNTI (if available), PREAMBLE_INDEX, and PREAMBLE_RECEIVED_TARGET_POWER.
[ . . . ]

### 5.1.4 Random Access Response Reception

Once the Random Access Preamble is transmitted and regardless of the possible occurrence of a measurement gap, the MAC entity shall:
1>if the contention-free Random Access Preamble for beam failure recovery request was transmitted by the MAC entity:
   2>if the contention-free Random Access Preamble for beam failure recovery request was transmitted on a non-terrestrial network:
      3>start the ra-ResponseWindow configured in BeamFailureRecoveryConfig at the PDCCH occasion as specified in TS 38.213 [6].
   2>else:
      3>start the ra-ResponseWindow configured in BeamFailureRecoveryConfig at the first PDCCH occasion as specified in TS 38.213 [6] from the end of the Random Access Preamble transmission.
   2>monitor for a PDCCH transmission on the search space indicated by recoverySearchSpaceId of the SpCell identified by the C-RNTI while ra-ResponseWindow is running.
1>else:
   2>if the Random Access Preamble was transmitted on a non-terrestrial network:
      3>start the ra-Response Window configured in RA CH-Config Common at the PDCCH occasion as specified in TS 38.213 [6].
   2>else:
      3>start the ra-ResponseWindow configured in RA CH-Config Common at the first PDCCH occasion as specified in TS 38.213 [6] from the end of the Random Access Preamble transmission.
   2>monitor the PDCCH of the SpCell for Random Access Response(s) identified by the RA-RNTI while the ra-ResponseWindow is running.
1>if notification of a reception of a PDCCH transmission on the search space indicated by recoverySearchSpaceId is received from lower layers on the Serving Cell where the preamble was transmitted; and
1>if PDCCH transmission is addressed to the C-RNTI; and
1>if the contention-free Random Access Preamble for beam failure recovery request was transmitted by the MAC entity:
   2>consider the Random Access procedure successfully completed.
1>else if a valid (as specified in TS 38.213 [6]) downlink assignment has been received on the PDCCH for the RA-RNTI and the received TB is successfully decoded:
   2>if the Random Access Response contains a MAC subPDU with Backoff Indicator:
      3>set the PREAMBLE_BACKOFF to value of the BI field of the MAC subPDU using Table 7.2-1, multiplied with SCALING_FACTOR_BI.
   2>else:
      3>set the PREAMBLE_BACKOFF to 0 ms.
   2>if the Random Access Response contains a MAC subPDU with Random Access Preamble identifier corresponding to the transmitted PREAMBLE_INDEX (see clause 5.1.3):
      3>consider this Random Access Response reception successful.
   2>if the Random Access Response reception is considered successful:
      3>if the Random Access Response includes a MAC subPDU with RAPID only:
         4>consider this Random Access procedure successfully completed;
         4>indicate the reception of an acknowledgement for SI request to upper layers.
      3>else:
         4>apply the following actions for the Serving Cell where the Random Access Preamble was transmitted:
         5>process the received Timing Advance Command (see clause 5.2);
         5>indicate the preambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP);
         5>if the Random Access procedure for an SCell is performed on uplink carrier where pusch-Config is not configured:
         6>ignore the received UL grant.
         5>else:
         6>process the received UL grant value and indicate it to the lower layers.
         4>if the Random Access Preamble was not selected by the MAC entity among the contention-based Random Access Preamble(s):
         5>consider the Random Access procedure successfully completed.
         4>else:
         5>set the TEMPORARY_C-RNTI to the value received in the Random Access Response;
         5>if this is the first successfully received Random Access Response within this Random Access procedure:
         6>if the transmission is not being made for the CCCH logical channel:
         7>indicate to the Multiplexing and assembly entity to include a C-RNTI MAC CE in the subsequent uplink transmission.
         6>if the Random Access procedure was initiated for SpCell beam failure recovery and spCell-BFR-CBRA with value true is configured:
         7>if there is at least one Serving Cell of this MAC entity configured with two BFD-RS sets:
         8>indicate to the Multiplexing and assembly entity to include an Enhanced BFR MAC CE or a Truncated Enhanced BFR MAC CE in the subsequent uplink transmission.
         7>else:
         8>indicate to the Multiplexing and assembly entity to include a BFR MAC CE or a Truncated BFR MAC CE in the subsequent uplink transmission.
         6>else if the Random Access procedure was initiated for beam failure recovery of both BFD-RS sets of SpCell:
         7>indicate to the Multiplexing and assembly entity to include an Enhanced BFR MAC CE or a Truncated Enhanced BFR MAC CE in the subsequent uplink transmission.
         6>obtain the MAC PDU to transmit from the Multiplexing and assembly entity and store it in the Msg3 buffer.
NOTE: If within a Random Access procedure, an uplink grant provided in the Random Access Response for the same group of contention-based Random Access Preambles has a different size than the first uplink grant allocated during that Random Access procedure, the UE behavior is not defined.
1>if ra-ResponseWindow configured in BeamFailureRecoveryConfig expires and if a PDCCH transmission on the search space indicated by recoverySearchSpaceId addressed to the C-RNTI has not been received on the Serving Cell where the preamble was transmitted; or
1>if ra-ResponseWindow configured in RACH-ConfigCommon expires, and if the Random Access Response containing Random Access Preamble identifiers that matches the transmitted PREAMBLE_INDEX has not been received:
   2>consider the Random Access Response reception not successful;
   2>increment PREAMBLE_TRANSMISSION_COUNTER by 1;
   2>if PREAMBLE_TRANSMISSION_COUNTER=preambleTransMax+1:
      3>if the Random Access Preamble is transmitted on the SpCell:
         4>indicate a Random Access problem to upper layers;
         4>if this Random Access procedure was triggered for SI request:
         5>consider the Random Access procedure unsuccessfully completed.
      3>else if the Random Access Preamble is transmitted on an SCell:
         4>consider the Random Access procedure unsuccessfully completed.
   2>if the Random Access procedure is not completed:
      3>select a random backoff time according to a uniform distribution between 0 and the PREAMBLE_BACKOFF;
      3>if the criteria (as defined in clause 5.1.2) to select contention-free Random Access Resources is met during the backoff time:
         4>perform the Random Access Resource selection procedure (see clause 5.1.2).
      3>else if the Random Access procedure for an SCell is performed on uplink carrier where pusch-Config is not configured:
         4>delay the subsequent Random Access transmission until the Random Access Procedure is triggered by a PDCCH order with the same ra-PreambleIndex, ra-ssb-OccasionMaskIndex, and UL/SUL indicator TS 38.212 [9].
      3>else:
         4>perform the Random Access Resource selection procedure (see clause 5.1.2) after the backoff time.

### 5.1.5 Contention Resolution

Once Msg3 is transmitted the MAC entity shall:
1>if the Msg3 transmission (i.e. initial transmission or HARQ retransmission) is scheduled with Type A PUSCH repetition:
   2>if Msg3 is transmitted on a non-terrestrial network:
      3>start or restart the ra-ContentionResolution Timer in the first symbol after the end of all repetitions of the Msg3 transmission plus the UE-gNB RTT.
   2>else:
      3>start or restart the ra-ContentionResolution Timer in the first symbol after the end of all repetitions of the Msg3 transmission.
1>else if Msg3 transmission (i.e. initial transmission or HARQ retransmission) is transmitted on a non-terrestrial network:
   2>start or restart the ra-ContentionResolutionTimer in the first symbol after the end of the Msg3 transmission plus the UE-gNB RTT.
1>else:
   2>start or restart the ra-ContentionResolutionTimer in the first symbol after the end of the Msg3 transmission.
1>monitor the PDCCH while the ra-ContentionResolutionTimer is running regardless of the possible occurrence of a measurement gap;
1>if notification of a reception of a PDCCH transmission of the SpCell is received from lower layers:
   2>if the C-RNTI MAC CE was included in Msg3:
      3>if the Random Access procedure was initiated for SpCell beam failure recovery or for beam failure recovery of both BFD-RS sets of SpCell (as specified in clause 5.17) and the PDCCH transmission is addressed to the C-RNTI; or
      3>if the Random Access procedure was initiated by a PDCCH order and the PDCCH transmission is addressed to the C-RNTI; or
      3>if the Random Access procedure was initiated by the MAC sublayer itself or by the RRC sublayer and the PDCCH transmission is addressed to the C-RNTI and contains a UL grant for a new transmission:
         4>consider this Contention Resolution successful;
         4>stop ra-ContentionResolutionTimer;
         4>discard the TEMPORARY_C-RNTI;
         4>consider this Random Access procedure successfully completed.
   2>else if the CCCH SDU was included in Msg3 and the PDCCH transmission is addressed to its TEMPORARY_C-RNTI:
      3>if the MAC PDU is successfully decoded:
         4>stop ra-ContentionResolutionTimer;
         4>if the MAC PDU contains a UE Contention Resolution Identity MAC CE; and
         4>if the UE Contention Resolution Identity in the MAC CE matches the CCCH SDU transmitted in Msg3:
         5>consider this Contention Resolution successful and finish the disassembly and demultiplexing of the MAC PDU;
         5>if this Random Access procedure was initiated for SI request:
         6>indicate the reception of an acknowledgement for SI request to upper layers.
         5>else:
         6>set the C-RNTI to the value of the TEMPORARY_C-RNTI;
         5>discard the TEMPORARY_C-RNTI;
         5>consider this Random Access procedure successfully completed.
         4>else:
         5>discard the TEMPORARY_C-RNTI;
         5>consider this Contention Resolution not successful and discard the successfully decoded MAC PDU.
1>if ra-ContentionResolutionTimer expires:
   2>if Msg3 transmission was transmitted on a non-terrestrial network:
      3>if no PDCCH addressed to TC-RNTI indicating uplink grant for a Msg3 retransmission is received after the start of the ra-ContentionResolutionTimer:
         4>discard the TEMPORARY_C-RNTI;
         4>consider the Contention Resolution not successful.
   2>else:
      3>discard the TEMPORARY_C-RNTI;
      3>consider the Contention Resolution not successful.
1>if the Contention Resolution is considered not successful:
   2>flush the HARQ buffer used for transmission of the MAC PDU in the Msg3 buffer;
   2>increment PREAMBLE_TRANSMISSION_COUNTER by 1;
   2>if PREAMBLE_TRANSMISSION_COUNTER=preambleTransMax+1:
      3>indicate a Random Access problem to upper layers.
      3>if this Random Access procedure was triggered for SI request:
         4>consider the Random Access procedure unsuccessfully completed.
   2>if the Random Access procedure is not completed:
      3>if the RA_TYPE is set to 4-stepRA:
         4>select a random backoff time according to a uniform distribution between 0 and the PREAMBLE_BACKOFF;
         4>if the criteria (as defined in clause 5.1.2) to select contention-free Random Access Resources is met during the backoff time:
         5>perform the Random Access Resource selection procedure (see clause 5.1.2);
         4>else:
         5>perform the Random Access Resource selection procedure (see clause 5.1.2) after the backoff time.
      3>else (i.e. the RA_TYPE is set to 2-stepRA):
         4>if msgA-TransMax is applied (see clause 5.1.1a) and PREAMBLE_TRANSMISSION_COUNTER=msgA-TransMax+1:
         5>set the RA_TYPE to 4-stepRA;
         5>perform initialization of variables specific to Random Access type as specified in clause 5.1.1a;
         5>flush HARQ buffer used for the transmission of MAC PDU in the MSGA buffer;
         5>discard explicitly signalled contention-free 2-step RA type Random Access Resources, if any;
         5>perform the Random Access Resource selection as specified in clause 5.1.2.
         4>else:
         5>select a random backoff time according to a uniform distribution between 0 and the PREAMBLE_BACKOFF;
         5>if the criteria (as defined in clause 5.1.2a) to select contention-free Random Access Resources is met during the backoff time:
         6>perform the Random Access Resource selection procedure for 2-step RA type as specified in clause 5.1.2a.
         5>else:
         6>perform the Random Access Resource selection for 2-step RA type procedure (see clause 5.1.2a) after the backoff time.

### 5.2 Maintenance of Uplink Time Alignment

RRC configures the following parameters for the maintenance of UL time alignment:
timeAlignmentTimer (per TAG) which controls how long the MAC entity considers the Serving Cells belonging to the associated TAG to be uplink time aligned;
inactivePosSRS-TimeAlignmentTimer which controls how long the MAC entity considers the Positioning SRS transmission in RRC_INACTIVE in clause 5.26 to be uplink time aligned;
cg-SDT-TimeAlignmentTimer which controls how long the MAC entity considers the uplink transmission for CG-SDT to be uplink time aligned.

The MAC entity shall:
1>when a Timing Advance Command MAC CE is received, and if an N_{TA} (as defined in TS 38.211 [8]) has been maintained with the indicated TAG:
   2>apply the Timing Advance Command for the indicated TAG;
   2>if inactivePosSRS-TimeAlignmentTimer is configured and there is ongoing Positioning SRS Transmission in RRC_INACTIVE as in clause 5.26:
      3>start or restart the inactivePosSRS-TimeAlignmentTimer associated with the indicated TAG.
   2>if CG-SDT procedure triggered as in clause 5.27 is ongoing:
      3>start or restart the cg-SDT-TimeAlignmentTimer associated with the indicated TAG.
   2>else:
      3>start or restart the timeAlignmentTimer associated with the indicated TAG.
1>when a Timing Advance Command is received in a Random Access Response message for a Serving Cell belonging to a TAG or in a MSGB for an SpCell:
   2>if the Random Access Preamble was not selected by the MAC entity among the contention-based Random Access Preamble:
      3>apply the Timing Advance Command for this TAG;
      3>start or restart the timeAlignmentTimer associated with this TAG.
   2>else if the timeAlignmentTimer associated with this TAG is not running:
      3>apply the Timing Advance Command for this TAG;
      3>start the timeAlignmentTimer associated with this TAG;
      3>when the Contention Resolution is considered not successful as described in clause 5.1.5; or
      3>when the Contention Resolution is considered successful for SI request as described in clause 5.1.5, after transmitting HARQ feedback for MAC PDU including UE Contention Resolution Identity MAC CE:
         4>stop timeAlignmentTimer associated with this TAG.
      3>when the Contention Resolution is considered not successful as described in clause 5.1.5:
         4>if CG-SDT procedure triggered as in clause 5.27 is ongoing:
         5>set the N_{TA} value to the value before applying the received Timing Advance Command as in TS 38.211 [8].
      3>when the Contention Resolution is considered successful for Random Access procedure while the CG-SDT procedure is ongoing:
         4>stop timeAlignmentTimer associated with this TAG;
         4>start or restart the cg-SDT-TimeAlignmentTimer associated with this TAG.
      3>when the Contention Resolution is considered successful for Random Access procedure while SRS transmission in RRC_INACTIVE is ongoing:
         4>start or restart the inactivePosSRS-TimeAlignmentTimer associated with this TAG.
   2>else:
      3>ignore the received Timing Advance Command.
1>when an Absolute Timing Advance Command is received in response to a MSGA transmission including C-RNTI MAC CE as specified in clause 5.1.4a:
   2>apply the Timing Advance Command for PTAG;
   2>if CG-SDT procedure is ongoing:
      3>start or restart the cg-SDT-TimeAlignmentTimer associated with PTAG.
   2>else:
      3>start or restart the timeAlignmentTimer associated with PTAG.
1>when the indication is received from upper layer for stopping the inactivePosSRS-TimeAlignmentTimer:
   2>stop the inactivePosSRS-TimeAlignmentTimer.
1>when the indication is received from upper layer for starting the inactivePosSRS-TimeAlignmentTimer:
   2>start or restart the inactivePosSRS-TimeAlignmentTimer.
1>when instruction from the upper layer has been received for starting the cg-SDT-TimeAlignmentTimer:
   2>start the cg-SDT-TimeAlignmentTimer.
1>when instruction from the upper layer has been received for stopping the cg-SDT-TimeAlignmentTimer:
   2>consider the cg-SDT-TimeAlignmentTimer as expired.
1>when instruction from the upper layer has been received for starting the TimeAlignmentTimer associated with PTAG:
   2>start the TimeAlignmentTimer associated with PTAG.
1>when a timeAlignmentTimer expires:
   2>if the timeAlignmentTimer is associated with the PTAG:
      3>flush all HARQ buffers for all Serving Cells;
      3>notify RRC to release PUCCH for all Serving Cells, if configured;
      3>notify RRC to release SRS for all Serving Cells, if configured;
      3>clear any configured downlink assignments and configured uplink grants;
      3>clear any PUSCH resource for semi-persistent CSI reporting;
      3>consider all running timeAlignmentTimers as expired;
      3>maintain N_{TA} (defined in TS 38.211 [8]) of all TAGs.
   2>else if the timeAlignmentTimer is associated with an STAG, then for all Serving Cells belonging to this TAG:
      3>flush all HARQ buffers;
      3>notify RRC to release PUCCH, if configured;
      3>notify RRC to release SRS, if configured;
      3>clear any configured downlink assignments and configured uplink grants;
      3>clear any PUSCH resource for semi-persistent CSI reporting;
      3>maintain N_{TA} (defined in TS 38.211 [8]) of this TAG.
1>when the inactivePosSRS-TimeAlignmentTimer expires:
   2>notify RRC to release Positioning SRS for RRC_INACTIVE configuration(s).
1>when the cg-SDT-TimeAlignmentTimer expires:
   2>clear any configured uplink grants;
   2>if a PDCCH addressed to the MAC entity's C-RNTI after initial transmission for the CG-SDT with CCCH message has not been received:
      3>consider ongoing CG-SDT procedure as terminated;
      3>indicate the expiry of cg-SDT-TimeAlignmentTimer to the upper layer.
   2>flush all HARQ buffers;
   2>maintain N_{TA} (defined in TS 38.211 [8]) of this TAG.

### 6.1.3.4 Timing Advance Command MAC CE

The Timing Advance Command MAC CE is identified by MAC subheader with LCID as specified in Table 6.2.1-1.

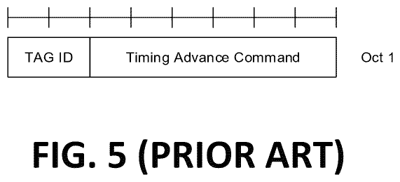

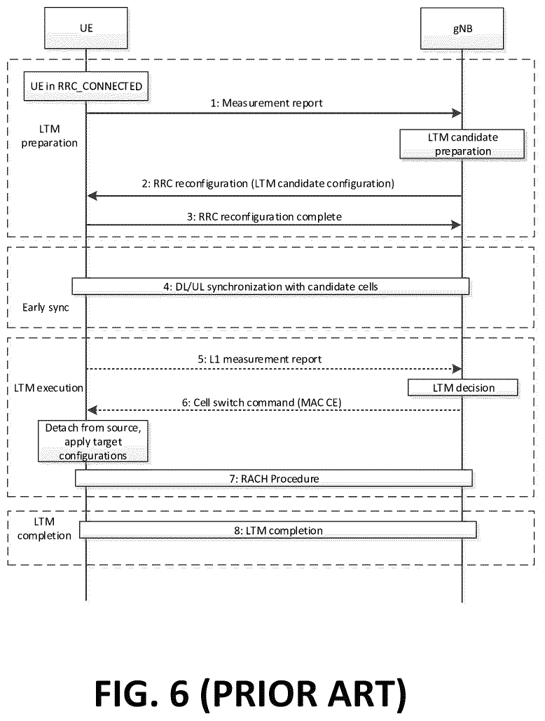

It has a fixed size and consists of a single octet defined as follows (Figure 6.1.3.4-1):
TAG Identity (TAG ID): This field indicates the TAG Identity of the addressed TAG. The TAG containing the SpCell has the TAG Identity 0. The length of the field is 2 bits;
Timing Advance Command: This field indicates the index value T_{A} (0, 1, 2 . . . 63) used to control the amount of timing adjustment that MAC entity has to apply (as specified in TS 38.213 [6]). The length of the field is 6 bits.
   FIG. 5 is a Reproduction of Figure 6.1.3.4-1: Timing Advance Command MAC CE, from 3GPP 38.321 v17.4.0

### 3.1 Definitions

Primary Cell: The MCG cell, operating on the primary frequency, in which the UE either performs the initial connection establishment procedure or initiates the connection re-establishment procedure.
Primary SCG Cell: For dual connectivity operation, the SCG cell in which the UE performs random access when performing the Reconfiguration with Sync procedure.
Secondary Cell: For a UE configured with CA, a cell providing additional radio resources on top of Special Cell.
Secondary Cell Group: For a UE configured with dual connectivity, the subset of serving cells comprising of the PSCell and zero or more secondary cells.
Serving Cell: For a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells.
Special Cell: For Dual Connectivity operation the term Special Cell refers to the PCell of the MCG or the PSCell of the SCG, otherwise the term Special Cell refers to the PCell.
Timing Advance Group: A group of Serving Cells that is configured by RRC and that, for the cells with a UL configured, using the same timing reference cell and the same Timing Advance value. A Timing Advance Group containing the SpCell of a MAC entity is referred to as Primary Timing Advance Group (PTAG), whereas the term Secondary Timing Advance Group (STAG) refers to other TAGs.

In 38.331 ([2] 3GPP 38.331 v17.4.0), random access information reporting and additional PCI configurations are introduced:

### 5.7.10.3 Reception of the UEInformationRequest Message

Upon receiving the UEInformationRequest message, the UE shall, only after successful security activation:
[ . . . ]
1>if ra-ReportReq is set to true and the UE has random access related information available in VarRA-Report and if the RPLMN is included in plmn-IdentityList stored in VarRA-Report:
   2>set the ra-ReportList in the UEInformationResponse message to the value of ra-ReportList in VarRA-Report;
   2>discard the ra-ReportList from VarRA-Report upon successful delivery of the UEInformationResponse message confirmed by lower layers;
1>if rlf-ReportReq is set to true:
   2>if the UE has radio link failure information or handover failure information available in VarRLF-Report and if the RPLMN is included in plmn-IdentityList stored in VarRLF-Report:
      3>set timeSinceFailure in VarRLF-Report to the time that elapsed since the last radio link failure or handover failure in NR;
      3>set the rlf-Report in the UEInformationResponse message to the value of rlf-Report in VarRLF-Report;
      3>discard the rlf-Report from VarRLF-Report upon successful delivery of the UEInformationResponse message confirmed by lower layers;
   2>else if the UE is capable of cross-RAT RLF reporting as defined in TS 38.306 [26] and has radio link failure information or handover failure information available in VarRLF-Report of TS 36.331 [10] and if the RPLMN is included in plmn-IdentityList stored in VarRLF-Report of TS 36.331 [10]:
      3>set timeSinceFailure in VarRLF-Report of TS 36.331 [10] to the time that elapsed since the last radio link failure or handover failure in EUTRA;
      3>set failedPCellId-EUTRA in the rlf-Report in the UEInformationResponse message to indicate the PCell in which RLF was detected or the source PCell of the failed handover in the VarRLF-Report of TS 36.331 [10];
      3>set the measResult-RLF-Report-EUTRA in the rlf-Report in the UEInformationResponse message to the value of rlf-Report in VarRLF-Report of TS 36.331 [10];
      3>discard the rlf-Report from VarRLF-Report of TS 36.331 [10] upon successful delivery of the UEInformationResponse message confirmed by lower layers;
1>if connEstFailReportReq is set to true and the UE has connection establishment failure or connection resume failure information in VarConnEstFailReport or VarConnEstFailReportList and if the RPLMN is equal to plmn-Identity stored in VarConnEstFailReport or in at least one of the entries of VarConnEstFailReportList:
   2>set timeSinceFailure in VarConnEstFailReport to the time that elapsed since the last connection establishment failure or connection resume failure in NR;
   2>set the connEstFailReport in the UEInformationResponse message to the value of connEstFailReport in VarConnEstFailReport;
   2>if the UE supports multiple CEF report:
      3>for each connEstFailReport in the connEstFailReportList in VarConnEstFailReportList:
         4>set timeSinceFailure to the time that elapsed since the associated connection establishment failure or connection resume failure in NR;
   2>for each connEstFailReport in the connEstFailReportList in the UEInformationResponse message, set the value to the value of connEstFailReport in VarConnEstFailReport in VarConnEstFailReportList;
   2>discard the connEstFailReport from VarConnEstFailReport and VarConnEstFailReportList upon successful delivery of the UEInformationResponse message confirmed by lower layers;
[ . . . ]
1>if the successHO-ReportReq is set to true and if the UE has successful handover related information available in VarSuccessHO-Report and if the RPLMN is included in the plmn-IdentityList stored in VarSuccessHO-Report:
   2>if the successHO-Report in the VarSuccessHO-Report concerns a DAPS handover and if a PDCP PDU has been received from the source cell of the concerned HO and a non-duplicated PDCP PDU has been received from the target cell of the concerned HO:
      3>set upInterruptionTimeAtHO in VarSuccessHO-Report to include the time elapsed between the time of arrival of the last PDCP PDU received from the source cell of the concerned handover and the time of arrival of the first non-duplicate PDCP PDU received from the target cell of the concerned handover, as measured at the time of arrival of the first non-duplicate PDCP PDU received from the target cell;
   2>set the successHO-Report in the UEInformationResponse message to the value of successHO-Report in the VarSuccessHO-Report, if available;
   2>discard the VarSuccessHO-Report upon successful delivery of the UEInformationResponse message confirmed by lower layers;
1>if the coarseLocationRequest is set to true:
   2>include coarseLocationInfo, if available;
1>if the logMeasReport is included in the UEInformationResponse:
   2>submit the UEInformationResponse message to lower layers for transmission via SRB2;
   2>discard the logged measurement entries included in the logMeasInfoList from VarLogMeasReport upon successful delivery of the UEInformationResponse message confirmed by lower layers;
1>else:
   2>submit the UEInformationResponse message to lower layers for transmission via SRB1.

### 5.7.10.4 Actions Upon Successful Completion of a Random-Access Procedure or on Completion of a Request of On-Demand System Information

Upon successfully performing random-access procedure initialized with 4-step or 2-step RA type, or upon failed or successfully completed on-demand system information acquisition procedure in RRC_IDLE or RRC_INACTIVE state, the UE shall:
1>if the RPLMN or the PLMN selected by upper layers (see TS24.501 [23]) from the PLMN(s) included in the plmn-IdentityList in SIB1 is not included in plmn-IdentityList stored in a non-empty VarRA-Report:
   2>clear the information included in VarRA-Report;
1>if the number of RA-Report entries stored in the ra-ReportList in VarRA-Report is less than maxRAReport:
   2>if the number of PLMN entries in plmn-IdentityList stored in VarRA-Report is less than maxPLMN; or
   2>if the number of PLMN entries in plmn-IdentityList stored in VarRA-Report is equal to maxPLMN and the list of EPLMNs is subset of or equal to the plmn-IdentityList stored in VarRA-Report:
      3>append the following contents associated to the successfully completed random-access procedure or the failed or successfully completed on-demand system information acquisition procedure as a new entry in the VarRA-Report:
         4>if the list of EPLMNs has been stored by the UE:
         5>set the plmn-IdentityList to include the list of EPLMNs stored by the UE (i.e. includes the RPLMN) without exceeding the limit of maxPLMN;
         4>else:
         5>set the plmn-Identity, in plmn-IdentityList, to the PLMN selected by upper layers (see TS 24.501 [23]) from the PLMN(s) included in the plmn-IdentityInfoList in SIB1;
         4>set the cellId to the global cell identity and the tracking area code, if available, otherwise to the physical cell identity and carrier frequency of the cell in which the corresponding random-access preamble was transmitted;
         4>if the UE supports spCell ID indication:
         5>if the corresponding random-access procedure was performed on an SCell of MCG:
         6>set the spCellId to the global cell identity of the PCell;
         5>if the corresponding random-access procedure was performed on an SCell of SCG; or
         5>if the corresponding random-access procedure was performed on PSCell:
         6>set the spCellId to the global cell identity of the PSCell, if available, otherwise, set the spCellId to the global cell identity of the PCell;
         4>set the raPurpose to include the purpose of triggering the random-access procedure;
         4>set the ra-InformationCommon as specified in clause 5.7.10.5.

The UE may discard the random access report information, i.e. release the UE variable VarRA-Report, 48 hours after the last successful random access procedure or the failed or successfully completed on-demand system information acquisition procedure related information is added to the VarRA-Report.
NOTE 1: The UE does not log the RA information in the RA report if the triggering event of the random access is consistent UL LBT on SpCell as specified in TS 38.321 [6].

### 5.7.10.5 RA Information Determination

The UE shall set the content in ra-InformationCommon as follows:
1>set the absoluteFrequencyPointA to indicate the absolute frequency of the reference resource block associated to the random-access resources used in the random-access procedure;
1>set the locationAndBandwidth and subcarrierSpacing associated to the UL BWP of the random-access resources used in the random-access procedure;
1>if contention based random-access resources are used in the random-access procedure:
   2>set the msgA_RO-FrequencyStart and msgA-RO-FDM and msgA-SubcarrierSpacing associated to the 2 step random-access resources if used in the random-access procedure;
   2>if msgA-SubcarrierSpacing associated to the 2 step random-access resources used in the random-access procedure is available:
      3>set the msgA-SubcarrierSpacing associated to the 2 step random-access resources used in the random-access procedure;
   2>else if only 2 step random-access resources are available in the UL BWP used in the random-access procedure:
      3>set the msgA-SCS-From-prach-ConfigurationIndex to the subcarrier spacing as derived from the msgA-PRACH-ConfigurationIndex used in the 2-step random-access procedure;
   2>else:
      3>set the msg1-SubcarrierSpacing associated to the 4 step random-access resources used in the random-access procedure;
   2>set the msg1-FrequencyStart associated to the 4 step random-access resources if used in the random-access procedure, and if its value is different from the value of msgA-RO-FrequencyStart if it is included in the ra-InformationCommon;
   2>set the msg1-FDM associated to the 4 step random-access resources if used in the random-access procedure, and if its value is different from the value of msgA-RO-FDMCFRA if it is included in the ra-InformationCommon;
   2>if msg1-SubcarrierSpacing associated to the 4 step random-access resources used in the random-access procedure is available, and if its value is different from the value of msgA-SubcarrierSpacing if it is included in the ra-InformationCommon:
      3>set the msg1-SubcarrierSpacing associated to the 4 step random-access resources used in the random-access procedure;
   2>else:
      3>set the msg1-SCS-From-prach-ConfigurationIndex to the subcarrier spacing as derived from the prach-ConfigurationIndex used in the 4-step random-access procedure, and if its value is different from the value of msgA-SCS-From-prach-ConfigurationIndex if it is included in the ra-InformationCommon;
1>if contention free random-access resources are used in the random-access procedure:
   2>set the msg1-FrequencyStartCFRA and msg1-FDMCFRA associated to the 4 step random-access resources if used in the random-access procedure;
   2>if msg1-SubcarrierSpacing associated to the 4 step random-access resources used in the random-access procedure is available:
      3>set the msg1-SubcarrierSpacingCFRA associated to the 4 step random-access resources used in the random-access procedure;
   2>else:
      3>set the msg1-SCS-From-prach-ConfigurationIndexCFRA to the subcarrier spacing as derived from the prach-ConfigurationIndex used in the 4 step random-access procedure;
   2>set the msgA-RO-FrequencyStartCFRA and msgA-RO-FDMCFRA associated to the 2 step contention free random access resources if used in the random-access procedure;
   2>set the msgA-MCS, the nrofPRBs-PerMsgA-PO, the msgA-PUSCH-TimeDomainAllocation, the frequencyStartMsgA-PUSCH, the nrofMsgA-PO-FDM associated to the 2 step random-access resources if used in the random-access procedure;
   2>if msgA-SubcarrierSpacing associated to the 2 step random-access resources used in the random-access procedure is available:
      3>set the msgA-SubcarrierSpacing associated to the 2 step random-access resources used in the random-access procedure;
   2>else if only 2 step random-access resources are available in the UL BWP used in the random-access procedure:
      3>set the msgA-SCS-From-prach-ConfigurationIndex to the subcarrier spacing as derived from the msgA-PRACH-ConfigurationIndex used in the 2-step random-access procedure;
   2>else:
      3>set the msg1-SubcarrierSpacing associated to the 4 step random-access resources used in the random-access procedure;
1>if the random access procedure is initialized with RA_TYPE set to 2-stepRA as described in TS 38.321 [3]:
   2>set the dlPathlossRSRP to the measured RSRP of the DL pathloss reference obtained at the time of RA_Type selection stage of the initialization of the RA procedure as captured in TS 38.321 [3];
   2>if the configuration for the random access msgA-TransMax was configured in RACH-ConfigDedicated for this random access procedure, and ra-Purpose is set to reconfigurationWithSync:
      3>set msgA-TransMax to the value of msgA-TransMax in RACH-ConfigDedicated;
   2>else if msgA-TransMax was configured in RACH-ConfigCommonTwoStepRA:
      3>set msgA-TransMax to the value of msgA-TransMax in RACH-ConfigCommonTwoStepRA;
   2>set the msgA-PUSCH-PayloadSize to the size of the overall payload available in the UE buffer at the time of initiating the 2 step RA procedure;
1>if the purpose of the random access procedure is to request on-demand system information (i.e., if the raPurpose is set to requestForOtherSI or msg3RequestForOtherSI):
   2>set the intendedSIBs to indicate the SIB(s) the UE wanted to receive as a result of the SI request;
   2>set the ssbsForSI-Acquisition to indicate the SSB(s) used to receive the SI message;
   2>if the on-demand system information acquisition was successful:
      3>set the onDemandSISuccess to true;
1>set the parameters associated to individual random-access attempt in the chronological order of attempts in the perRAInfoList as follows:
   2>if the random-access resource used is associated to a SS/PBCH block, set the associated random-access parameters for the successive random-access attempts associated to the same SS/PBCH block for one or more random-access attempts as follows:
      3>set the ssb-Index to include the SS/PBCH block index associated to the used random-access resource;
      3>set the numberOfPreamblesSentOnSSB to indicate the number of successive random-access attempts associated to the SS/PBCH block;
      3>for each random-access attempt performed on the random-access resource, include the following parameters in the chronological order of the random-access attempt:
         4>if the random-access attempt is performed on the contention based random-access resource and if raPurpose is not equal to ‘requestForOtherSI’, include contentionDetected as follows:
         5>if contention resolution was not successful as specified in TS 38.321 [6] for the transmitted preamble:
         6>set the contentionDetected to true;
         5>else:
         6>set the contentionDetected to false;
         4>if the random access attempt is a 2-step random access attempt:
         5>if fallback from 2-step random access to 4-step random access occurred during the random access attempt:
         6>set fallbackToFourStepRA to true;
         4>if the random-access attempt is performed on the contention based random-access resource; or
         4>if the random-access attempt is performed on the contention free random-access resource and if the random-access procedure was initiated due to the PDCCH ordering:
         5>if the random access attempt is a 4-step random access attempt and the SS/PBCH block RSRP of the SS/PBCH block corresponding to the random-access resource used in the random-access attempt is above rsrp-ThresholdSSB; or
         5>if the random access attempt is a 2-step random access attempt and the SS/PBCH block RSRP of the SS/PBCH block corresponding to the random-access resource used in the random-access attempt is above msgA-RSRP-ThresholdSSB:
         6>set the dlRSRPAboveThreshold to true;
         5>else:
         6>set the dlRSRPAboveThreshold to false;
   2>else if the random-access resource used is associated to a CSI-RS, set the associated random-access parameters for the successive random-access attempts associated to the same CSI-RS for one or more random-access attempts as follows:
      3>set the csi-RS-Index to include the CSI-RS index associated to the used random-access resource;
      3>set the numberOfPreamblesSentOnCSI-RS to indicate the number of successive random-access attempts associated to the CSI-RS.

### 5.7.10.6 Actions for the Successful Handover Report Determination

The UE shall for the PCell:
1>if the ratio between the value of the elapsed time of the timer T304 and the configured value of the timer T304, included in the last applied RRCReconfiguration message including the reconfigurationWithSync, is greater than thresholdPereentageT304 if included in the successHO-Config received before executing the last reconfiguration with sync; or
1>if the ratio between the value of the elapsed time of the timer T310 and the configured value of the timer T310, configured while the UE was connected to the source PCell before executing the last reconfiguration with sync, is greater than thresholdPereentageT310 included in the successHO-Config if configured by the source PCell before executing the last reconfiguration with sync; or
1>if the T312 associated to the measurement identity of the target cell was running at the time of initiating the execution of the reconfiguration with sync procedure and if the ratio between the value of the elapsed time of the timer T312 and the configured value of the timer T312, configured while the UE was connected to the source PCell before executing the last reconfiguration with sync, is greater than thresholdPercentageT312 included in the successHO-Config if configured by the source PCell before executing the last reconfiguration with sync; or
1>if sourceDAPS-FailureReporting is included in the successHO-Config before executing the last reconfiguration with sync and is set to true and if the last executed handover was a DAPS handover and if an RLF occurred at the source PCell during the DAPS handover while T304 was running:
   2>store the successful handover information in VarSuccessHO-Report and determine the content in VarSuccessHO-Report as follows:
      3>clear the information included in VarSuccessHO-Report, if any;
      3>set the plmn-IdentityList to include the list of EPLMNs stored by the UE (i.e., includes the RPLMN);
      3>set the e-RNTI to the C-RNTI assigned by the target PCell of the handover;
      3>for the source PCell in which the last RRCReconfiguration message including reconfigurationWithSync was applied:
         4>set the sourceCellID in sourceCellInfo to the global cell identity and tracking area code, if available, of the source PCell;
         4>set the sourceCellMeas in sourceCellInfo to include the cell level RSRP, RSRQ and the available SINR, of the source PCell based on the available SSB and CSI-RS measurements collected up to the moment the UE sends RRCReconfigurationComplete message;
         4>set the rsIndexResults in sourceCellMeas to include all the available SSB and CSI-RS measurement quantities of the source PCell collected up to the moment the UE sends RRCReconfigurationComplete message;
         4>if the last executed handover was a DAPS handover and if an RLF occurred at the source PCell during the DAPS handover while T304 was running:
         5>set the rlf-InSourceDAPS in sourceCellInfo to true;
      3>for the target PCell indicated in the last applied RRCReconfiguration message including reconfigurationWithSync:
         4>set the targetCellID in targetCellInfo to the global cell identity and tracking area code, if available, of the target PCell;
         4>set the targetCellMeas in targetCellInfo to include the cell level RSRP, RSRQ and the available SINR, of the target PCell based on the available SSB and CSI-RS measurements collected up to the moment the UE sends RRCReconfigurationComplete message;
         4>set the rsIndexResults in targetCellMeas to include all the available SSB and CSI-RS measurement quantities of the target PCell collected up to the moment the UE sends RRCReconfigurationComplete message;
         4>if the last applied RRCReconfiguration message including reconfigurationWithSync was included in the stored condRRCReconfig:
         5>set the timeSinceCHO-Reconfig to the time elapsed between the initiation of the execution of conditional reconfiguration for the target PCell and the reception of the last conditionalReconfiguration including the condRRCReconfig of the target PCell in the source PCell;
      3>if the ratio between the value of the elapsed time of the timer T304 and the configured value of the T304 timer, included in the last applied RRCReconfiguration message including the reconfigurationWithSync, is greater than thresholdPercentageT304 if included in the successHO-Config received before executing the last reconfiguration with sync:
         4>set t304-cause in shr-Cause to true;
         4>set the ra-InformationCommon to include the random-access related information associated to the random access procedure in the target PCell, as specified in clause 5.7.10.5;
      [ . . . ]
      3>if available, set the locationInfo as in 5.3.3.7;
1>release successHO-Config configured by the source PCell and thresholdPercentageT304 if configured by the target PCell.

The UE may discard the successful handover information, i.e., release the UE variable VarSuccessHO-Report, 48 hours after the last successful handover information is added to the VarSuccessHO-Report.
VarRA-Report

The UE variable VarRA-Report includes the random-access related information.

### VarRA-Report UE Variable

| | |
|---|---|
| VarRA-Report-r16 ::= | SEQUENCE { |
| ra-ReportList-r16 | RA-ReportList-r16, |
| plmn-IdentityList-r16 | PLMN-IdentityList-r16 |
| } | |
| PLMN-IdentityList-r16 ::= | SEQUENCE (SIZE |
| | (1..maxPLMN)) OF PLMN-Identity |

### UEInformationResponse

The UEInformationResponse message is used by the UE to transfer information requested by the network.
Signalling radio bearer: SRB1 or SRB2 (when logged measurement information is included)
RLC-SAP: AM
Logical channel: DCCH
Direction: UE to network

### UEInformationResponse Message

| UEInformationResponse-r16 ::= | SEQUENCE { | |
|---|---|---|
| rrc-TransactionIdentifier | RRC-TransactionIdentifier, | |
| criticalExtensions | CHOICE { | |
| ueInformationResponse-r16 | UEInformationResponse-r16-IEs, | |
| criticalExtensionsFuture | SEQUENCE { } | |
| } | | |
| } | | |
| UEInformationResponse-r16-IEs ::= | SEQUENCE { | |
| measResultIdleEUTRA-r16 | MeasResultIdleEUTRA-r16 | OPTIONAL, |
| measResultIdleNR-r16 | MeasResultIdleNR-r16 | OPTIONAL, |
| logMeasReport-r16 | LogMeasReport-r16 | OPTIONAL, |
| connEstFailReport-r16 | ConnEstFailReport-r16 | OPTIONAL, |
| ra-ReportList-r16 | RA-ReportList-r16 | OPTIONAL, |
| rlf-Report-r16 | RLF-Report-r16 | OPTIONAL, |
| mobilityHistoryReport-r16 | MobilityHistoryReport-r16 | OPTIONAL, |
| lateNonCriticalExtension | OCTET STRING | OPTIONAL, |
| nonCriticalExtension | UEInformationResponse-v1700-IEs | OPTIONAL |
| } | | |
| UEInformationResponse-v1700-IEs ::= | SEQUENCE { | |
| successH0-Report-r17 | SuccessH0-Report-r17 | OPTIONAL, |
| connEstFailReportList-r17 | ConnEstFailReportList-r17 | OPTIONAL, |
| coarseLocationInfo-r17 | OCTET STRING | OPTIONAL, |
| nonCriticalExtension | SEQUENCE { } | OPTIONAL |
| } | | |
| RA-ReportList-r16 ::= Sequence (Size (1..maxRAReport-r16)) OF RA-Report-r16 | | |
| RA-ReportList-r16 ::= | Sequence { | |
| cellId-r16 | CHOICE { | |
| cellGlobalId-r16 | CGI-Info-Logging-r16, | |
| pci-arfcn-r16 | PCI-ARFCN-NR-r16 | |
| }, | | |
| ra-InformationCommon-r16 | RA-InformationCommon-r16 | OPTIONAL, |
| raPurpose-r16 | ENUMERATED {accessRelated, beamFailureRecovery, | |
| reconfigurationWithSync, ulUnSynchronized, | | |
| | schedulingRequestFailure, | |
| noPUCCHResourceAvailable, requestForOtherSI, | | |
| | msg3RequestForOtherSI-r17, spare8, spare7, | |
| spare6, spare5, spare4, spare3, | | |
| | spare2, spare1}, | |
| ..., | | |
| [[ | | |
| spCellID-r17 | CGI-Info-Logging-r16, | OPTIONAL |
| ]] | | |
| } | | |
| Ra-InformationCommon-r16 ::= | SEQUENCE { | |
| absoluteFrequencyPointA-r16 | ARFCN-ValueNR, | |
| locationAndBandwidth-r16 | INTEGER (0..37949), | |
| subcarrierSpacing-r16 | SubcarrierSpacing, | |
| msg1-FrequencyStart-r16 | INTEGER (0..maxNrofPhysicalResourceBlocks-1) | OPTIONAL, |
| msg1-FrequencyStartCFRA-r16 | INTEGER (0..maxNrofPhysicalResourceBlocks-1) | OPTIONAL, |
| msg1-SubcarrierSpacing-r16 | SubcarrierSpacing | OPTIONAL, |
| msg1-SubcarrierSpacingCFRA-r16 | SubcarrierSpacing | OPTIONAL, |
| msg1-FDM-r16 | ENUMERATED {one, two, four, eight} | OPTIONAL, |
| msg1-FDMCFRA-r16 | ENUMERATED {one, two, four, eight} | OPTIONAL, |
| perRAInfoList-r16 | PerRAInfoList-r16, | |
| ..., | | |
| [[ | | |
| perRAInfoList-v1660 | PerRAInfoList-v1660 | OPTIONAL |
| ]], | | |
| [[ | | |

msg1-SCS-From-prach-ConfigurationIndex-r16 ENUMERATED {kHz1dot25, kHz5, spare2, spare1}

```
OPTIONAL
  ]],
  [[
```

msg1-SCS-From-prach-ConfigurationIndexCFRA-r16 ENUMERATED {kHz1dot25, kHz5, spare2, spare1}

| | | |
|---|---|---|
| OPTIONAL | | |
| ]], | | |
| [[ | | |
| msgA-RO-FrequencyStart-r17 | INTEGER (0..maxNrofPhysicalResourceBlocks-1) | OPTIONAL, |
| msgA-RO-FrequencyStartCFRA-r17 | INTEGER (0..maxNrofPhysicalResourceBlocks-1) | OPTIONAL, |
| msgA-SubcarrierSpacing-r17 | SubcarrierSpacing | OPTIONAL, |
| msgA-RO-FDM-r17 | ENUMERATED {one, two, four, eight} | OPTIONAL, |
| msgA-RO-FDMCFRA-r17 | ENUMERATED {one, two, four, eight} | OPTIONAL, |

msgA-SCS-From-prach-ConfigurationIndex-r17 ENUMERATED {kHz1dot25, kHz5, spare2, spare1}

| OPTIONAL, | | | |
|---|---|---|---|
| msgA-TransMax-r17 | ENUMERATED {n1, n2, n4, n6, n8, n10, n20, n50, n100, n200} | | |
| OPTIONAL, | | | OPTIONAL, |
| msgA-MCS-r17 | INTEGER (0..15) | | OPTIONAL, |
| nrofPRBs-PerMsgA-PO-r17 | INTEGER (1..32) | | OPTIONAL, |
| msgA-PUSCH-TimeDomainAllocation-r17 | INTEGER (1..maxNrofUL-Allocations) | | OPTIONAL, |
| frequencyStartMsgA-PUSCH-r17 | INTEGER (0..maxNrofPhysicalResourceBlocks-1) | | OPTIONAL, |
| nrofMsgA-PO-FDM-r17 | ENUMERATED {one, two, four, eight} | | OPTIONAL, |
| dlPathlossRSRP-r17 | RSRP-Range | | OPTIONAL, |
| intendedSIBs-r17 | SEQUENCE (SIZE (1..maxSIB)) OF SIB-Type-r17 | | OPTIONAL, |
| ssbsForSI-Acquisition-r17 | SEQUENCE (SIZE (1..maxNrofSSBs-r16)) OF SSB-Index | | |
| OPTIONAL, | | | |
| msgA-PUSCH-PayloadSize-r17 | BIT STRING (SIZE (5)) | | OPTIONAL, |
| onDemandSISuccess-r17 | ENUMERATED {true} | | OPTIONAL |
| ]] | | | |
| } | | | |
| PerRAInfoList-r16 ::= SEQUENCE (SIZE (1..200)) OF PerRAInfo-r16 | | | |
| PerRAInfoList-v1660 ::= SEQUENCE (SIZE (1..200)) OF PerRACSI-RSInfo-r16 | | | |
| PerRAInfo-r16 ::= | CHOICE { | | |
| perRASSBInfoList-r16 | PerRASSBInfo-r16, | | |
| perRACSI-RSInfoList-r16 | PerRACSI-RSInfo-r16 | | |
| } | | | |
| PerRASSBInfo-r16 ::= | SEQUENCE { | | |
| ssb-Index-r16 | SSB-Index, | | |
| numberOfPreambleSentOnSSB-r16 | INTEGER (1..200), | | |
| perRAAttemptInfoList-r16 | PerRAAttemptInfoList-r16 | | |
| } | | | |
| PerRACSI-RSInfo-r16 ::= | SEQUENCE { | | |
| csi-RS-Index-r16 | CSI-RS-Index, | | |
| numberOfPreambleSentOnCSI-RS-r16 | INTEGER (1..200) | | |
| } | | | |
| PerRACSI-RSInfo-v1660 ::= | SEQUENCE { | | |
| csi-RS-Index-v1660 | INTEGER (1..96) | | OPTIONAL |
| } | | | |
| PerRAAttemptInfoList-r16 ::= | SEQUENCE (SIZE (1..200)) OF PerRAAttemptInfo-r16 | | |
| PerRAAttemptInfo-r16 ::= | SEQUENCE { | | |
| contentionDetected-r16 | BOOLEAN | OPTIONAL, | |
| dlRSRPAboveThreshold-r16 | BOOLEAN | OPTIONAL, | |
| ..., | | | |
| [[ | | | |
| fallbackToFourStepRA-r17 | ENUMERATED {true} | OPTIONAL | |

]]
}

SIB-Type-r17 ::= ENUMERATED {sibType2, sibType3, sibType4, sibType5, sibType9, sibType10-v1610,

sibType11-v1610, sibType12-v1610,

sibType13-v1610, sibType14-v1610, spare6, spare5, spare4, spare3,

| spare2, spare1} | |
|---|---|
| ... | |
| SuccessHO-Report-r17 ::= | SEQUENCE { |
| sourceCellInfo-r17 | SEQUENCE { |
| sourcePCellId-r17 | CGI-InfoLogging-r16, |
| sourceCellMeas-r17 | MeasResultSuccessHONR-r17 |
| OPTIONAL, | |
| rlf-InSourceDAPS-r17 | ENUMERATED {true} |
| OPTIONAL | |
| }, | |
| targetCellInfo-r17 | SEQUENCE { |
| targetPCellId-r17 | CGI-InfoLogging-r16, |
| targetCellMeas-r17 | MeasResultSuccessHONR-r17 |
| OPTIONAL | |
| }, | |
| measResultNeighCells-r17 | SEQUENCE { |
| measResultListNR-r17 | MeasResultList2NR-r16 |
| OPTIONAL, | |
| measResultListEUTRA-r17 | MeasResultList2EUTRA-r16 |
| OPTIONAL | |
| } | |
| OPTIONAL, | |
| locationInfo-r17 | LocationInfo-r16 |
| OPTIONAL, | |
| timeSinceCHO-Reconfig-r17 | TimeSinceCHO-Reconfig-r17 |
| OPTIONAL, | |
| shr-Cause-r17 | SHR-Cause-r17 |
| OPTIONAL, | |
| ra-InformationCommon-r17 | RA-InformationCommon-r16 |
| OPTIONAL, | |
| upInterruptionTimeAtHO-r17 | UPInterruptionTimeAtHO-r17 |
| OPTIONAL, | |
| c-RNTI-r17 | RNTI-Value |
| OPTIONAL, | |
| ... | |
| } | |
| MeasResultList2NR-r16 ::= | SEQUENCE (SIZE (1..maxFreq)) OF MeasResult2NR-r16 |
| MeasResultList2EUTRA-r16 ::= | SEQUENCE (SIZE (1..maxFreq)) OF MeasResult2EUTRA-r16 |
| MeasResult2NR-r16 ::= | SEQUENCE { |
| ssbFrequency-r16 | ARFCN-ValueNR |
| OPTIONAL, | |
| refFreqCSI-RS-r16 | ARFCN-ValueNR |
| OPTIONAL, | |
| measResultList-r16 | MeasResultListNR |
| } | |
| MeasResultListLogging2NR-r16 ::= | SEQUENCE (SIZE (1..maxFreq)) OF MeasResultLogging2NR-r16 |
| MeasResultLogging2NR-r16 ::= | SEQUENCE { |
| carrierFreq-r16 | ARFCN-ValueNR, |
| measResultListLoggingNR-r16 | MeasResultListLoggingNR-r16 |
| } | |
| MeasResultListLoggingNR-r16 ::= | SEQUENCE (SIZE (1..maxCellReport)) OF MeasResultLoggingNR-r16 |
| MeasResultLoggingNR-r16 ::= | SEQUENCE { |
| physCellId-r16 | PhysCellId, |
| resultsSSB-Cell-r16 | MeasQuantityResults, |
| numberOfGoodSSB-r16 | INTEGER (1..maxNrofSSBs-r16) OPTIONAL |
| } | |
| ... | |
| MeasResult SuccessHONR-r17 ::= | SEQUENCE { |
| measResult-r17 | SEQUENCE { |
| cellResults-r17 | SEQUENCE { |
| resultsSSB-Cell-r17 | MeasQuantityResults |
| OPTIONAL, | |
| resultsCSI-RS-Cell-r17 | MeasQuantityResults |
| OPTIONAL | |
| }, | |
| rsIndexResults-r17 | SEQUENCE { |
| resultsSSB-Indexes-r17 | ResultsPerSSB-IndexList |
| OPTIONAL, | |
| resultsCSI-RS-Indexes-r17 | ResultsPerCSI-RS-IndexList |
| OPTIONAL | |
| } | |
| } | |
| } | |
| ChoCandidateCellList-r17 ::= | SEQUENCE (SIZE (1..maxNrofCondCells-r16)) OF ChoCandidateCell-r17 |
| ChoCandidateCell-r17 ::= | CHOICE { |
| cellGlobalId-r17 | CGI-Info-Logging-r16, |
| pci-arfcn-r17 | PCI-ARFCN-NR-r16 |
| } | |
| SHR-Cause-r17 ::= | SEQUENCE { |
| t304-cause-r17 | ENUMERATED {true} |
| OPTIONAL, | |
| t310-cause-r17 | ENUMERATED {true} |
| OPTIONAL, | |
| t312-cause-r17 | ENUMERATED {true} |
| OPTIONAL, | |
| sourceDAPS-Failure-r17 | ENUMERATED {true} |
| OPTIONAL, | |
| ... | |
| } | |

UEInformationResponse-IEs field descriptions
coarseLocationInfo
Parameter type Ellipsoid-Point defined in TS 37.355 [49]. The first/leftmost bit of the first octet contains the most
significant bit. The least significant bits of degreesLatitude and degreesLongitude are set to 0 to meet the accuracy
requirement corresponds to a granularity of approximately 2 km.
It is up to UE implementation how many LSBs are set to 0 to meet the accuracy requirement.
ra-ReportList
This field is used to provide the list of RA reports that is stored by the UE for the past upto maxRAReport-r16 number of
successful random access procedures, or failed or successful completion of on-demand system information request
procedure.
successHO-Report
This field is used to provide the successful handover report if triggered based on the successful handover configuration.
RA-InformationCommon field descriptions
absoluteFrequencyPointA
This field indicates the absolute frequency position of the reference resource block (Common RB 0).
locationAndBandwidth
Frequency domain location and bandwidth of the bandwidth part associated to the random-access resources used by
the UE.
perRAInfoList, perRAInfoList-v1660
This field provides detailed information about each of the random access attempts in the chronological order of the
random access attempts. If perRAInfoList-v1660 is present, it shall contain the same number of entries, listed in the
same order as in perRAInfoList-r16.
subcarrierSpacing
Subcarrier spacing used in the BWP associated to the random-access resources used by the UE.
RA-Report field descriptions
cellID
This field indicates the CGI of the cell in which the associated random access procedure was performed.
contentionDetected
This field is used to indicate that contention was detected for the transmitted preamble in the given random access
attempt or not. This field is not included when the UE performs random access attempt is using contention free random-
access resources or when the raPurpose is set to requestForOtherSI or when the RA attempt is a 2-step RA attempt
and fallback to 4-step RA did not occur (i.e. fallbackToFourStepRA is not included).
csi-RS-Index, csi-RS-Index-v1660
This field is used to indicate the CSI-RS index corresponding to the random access attempt.
If the random access procedure is for beam failure recovery, the field indicates the NZP-CSI-RS-Resourceld. For CSI-
RS index larger than maxNrofCSI-RS-ResourcesRRM-1, the index value is the sum of csi-RS-Index (without suffix) and
csi-RS-Index-v1660.
dlPathlossRSRP
Measeured RSRP of the DL pathloss reference obtained at the time of RA_Type selection stage of the RA procedure as
captured in TS 38.321 [3].
dlRSRPAboveThreshold
In 4 step random access procedure, this field is used to indicate whether the DL beam (SSB) quality associated to the
random access attempt was above or below the threshold rsrp-ThresholdSSB in beamFailureRecoveryConfig in UL
BWP configuration of UL BWP selected for random access procedure initiated for beam failure recovery; Otherwise,
rsrp-ThresholdSSB in rach-ConfigCommon in UL BWP configuration of UL BWP selected for random access procedure.
In 2 step random access procedure, this field is used to indicate whether the DL beam (SSB) quality associated to the
random access attempt was above or below the threshold msgA-RSRP-ThresholdSSB in rach-
ConfigCommonTwoStepRA in UL BWP configuration of UL BWP selected for random access procedure.
fallbackToFourStepRA
This field indicates if a fallback indication in MsgB is received (according to TS 38.321 [3]) for the 2-step random access
attempt.
intendedSIBs
This field indicates the SIB(s) the UE wanted to receive as a result of the on demand SI request (when the RA
procedure is a used as a SI request) initiated by the UE. That is, it indicates the one(s) of the SIB(s) in the SI
message(s) requested to be broadcast that the UE was interested in.
msg1-SCS-From-prach-ConfigurationIndex
This field is set by the UE with the corresponding SCS for CBRA as derived from the prach-ConfigurationIndex in
RACH-ConfigGeneric when the msg1-SubcarrierSpacing is absent; otherwise, this field is absent.
msg1-SCS-From-prach-ConfigurationIndexCFRA
This field is set by the UE with the corresponding SCS for CFRA as derived from the prach-ConfigurationIndex in
RACH-ConfigGeneric when the msg1-SubcarrierSpacing is absent; otherwise, this field is absent.
msgA-PUSCH-PayloadSize
This field indicates the size of the overall payload available in the UE buffer at the time of initiating the 2 step RA
procedure. The value refers to the index of TS 38.321 [3], table 6.1.3.1-1, corresponding to the UE buffer size.
msgA-RO-FDM
This field indicates the number of msgA PRACH transmission occasions Frequency-Division Multiplexed in one time
instance for the PRACH resources configured for 2-step CBRA..
msgA-RO-FDMCFRA
This field indicates the number of msgA PRACH transmission occasions Frequency-Division Multiplexed in one time
instance for the PRACH resources configured for 2-step CFRA.
msgA-RO-FrequencyStart
This field indicates the lowest resource block of the contention based random-access resources for 2-step CBRA in the
random-access procedure. The indication has the form of the offset of the lowest PRACH transmissions occasion with
respect to PRB 0 in the frequency domain.
msgA-RO-FrequencyStartCFRA
This field indicates the lowest resource block of the contention free random-access resources for the 2-step CFRA in
the random-access procedure. The indication has the form of the offset of the lowest PRACH transmissions occasion
with respect to PRB 0 in the frequency domain.
msgA-SCS-From-prach-ConfigurationIndex
This field is set by the UE with the corresponding SCS as derived from the msgA-PRACH-ConfigurationIndex in RACH-
ConfigGenericTwoStepRA (see tables Table 6.3.3.1-1, Table 6.3.3.1-2, Table 6.3.3.2-2 and Table 6.3.3.2-3, TS 38.211
[16]) when the msgA-SubcarrierSpacing is absent and when only 2-step random-access resources are available in the
UL BWP used in the random-access procedure; otherwise, this field is absent.
numberOfPreamblesSentOnCSI-RS
This field is used to indicate the total number of successive RA preambles that were transmitted on the corresponding
CSI-RS.
numberOfPreamblesSentOnSSB
This field is used to indicate the total number of successive RA preambles that were transmitted on the corresponding
SS/PBCH block.
onDemandSISuccess
This field is set to true when the RA report entry is included because of either msg1 based on demand SI request or
msg3 based on demand SI request and if the on-demand SI request is successful. Otherwise, the field is absent.
perRAAttemptInfoList
This field provides detailed information about a random access attempt.
perRACSI-RSInfoList
This field provides detailed information about the successive random access attempts associated to the same CSI-RS.
perRASSBInfoList
This field provides detailed information about the successive random access attempts associated to the same
SS/PBCH block.
ra-InformationCommon
This field is used to provide information on random access attempts. This field is mandatory present.
raPurpose
This field is used to indicate the RA scenario for which the RA report entry is triggered. The RA accesses associated to
Initial access from RRC_IDLE, RRC re-establishment procedure, transition from RRC-INACTIVE. The indicator
beamFailureRecovery is used in case of successful beam failure recovery related RA procedure in the SpCell [3]. The
indicator reconfigurationWithSync is used if the UE executes a reconfiguration with sync. The indicator
ulUnSynchronized is used if the random access procedure is initiated in a SpCell by DL or UL data arrival during
RRC_CONNECTED when the timeAlignmentTimer is not running in the PTAG or if the RA procedure is initiated in a
serving cell by a PDCCH order [3]. The indicator schedulingRequestFailure is used in case of SR failures [3]. The
indicator noPUCCHResourceAvailable is used when the UE has no valid SR PUCCH resources configured [3]. The
indicator requestForOtherSI is used for MSG1 based on demand SI request. The indicator msg3RequestForOtherSI is
used in case of MSG3 based SI request. The field can also be used for the SCG-related RA-Report when the
raPurpose is set to beamFailureRecovery, reconfigurationWithSync, ulUnSynchronized, schedulingRequestFailure and
noPUCCHResourceAvailable.
spCellID
This field is used to indicate the CGI of the SpCell of the cell group associated to the SCell in which the associated
random access procedure was performed. If the UE performs RA procedure on a SCell associated to the MCG, then
this field is set to the CGI of the PCell and if the UE performs RA procedure on a SCell associated to the SCG, then this
field is set to the CGI of the PSCell. If the CGI of the PSCell is not available at the UE for the RA procedure performed
on a SCell associated to the SCG or for the RA procedure on the PSCell, this field is set to the CGI of the PCell.
Otherwise, the field is absent.
ssb-Index
This field is used to indicate the SS/PBCH index of the SS/PBCH block corresponding to the random access attempt.
ssbsForSI-Acquisition
This field indicates the SSB(s) (in the form of SSB index(es)) that the UE used to receive the requested SI message(s).
The field is present if the purpose of the random access procedure was to request on-demand SI (i.e. if the raPurpose is
set to requestForOtherSI or msg3RequestForOtherSI). Otherwise, the field is absent.

### PCI-ARFCN-NR

The IE PCI-ARFCN-NR is used to encode NR PCI and ARFCN.

### PCI-ARFCN-NR Information Element

| | |
|---|---|
| PCI-ARFCN-NR-r16 ::= | SEQUENCE { |
| physCellId-r16 | PhysCellId, |
| carrierFreq-r16 | ARFCN-ValueNR |
| } | |

### CGI-Info-Logging

The IE CGI-Info-Logging indicates the NR Cell Global Identifier (NCGI) for logging purposes (e.g. RLF report), the globally unique identity, and the TAC information of a cell in NR.

### CGI-Info-Logging Information Element

| | | | |
|---|---|---|---|
| CGI-Info-Logging-r16 ::= | SEQUENCE { | | |
| plmn-Identity-r16 | | PLMN-Identity, | |
| cellIdentity-r16 | | CellIdentity, | |
| trackingAreaCode-r16 | | TrackingAreaCode | OPTIONAL |
| } | | | |

CGI-Info-Logging field descriptions

cellIdentity
Unambiguously identify a cell within the context of the PLMN. It belongs the first PLMN-IdentityInfo IE of PLMN-
IdentityInfoList in SIB1.
plmn-Identity
Identifies the PLMN of the cell for the reported cellIdentity: the first PLMN entry of plmn-IdentityList (in SIB1) in the
instance of PLMN-IdentityInfoList that contained the reported cellIdentity.
trackingAreaCode
Indicates Tracking Area Code to which the cell indicated by cellIdentity field belongs.

### CSI-SSB-ResourceSet

The IE CSI-SSB-ResourceSet is used to configure one SS/PBCH block resource set which refers to SS/PBCH as indicated in ServingCellConfigCommon and ServingCellConfig.

### CSI-SSB-ResourceSet Information Element

| CSI-SSB-ResourceSet ::= | | SEQUENCE { |
|---|---|---|
| csi-SSB-ResourceSetId | | CSI-SSB-ResourceSetId, |
| csi-SSB-ResourceList | | SEQUENCE (SIZE (1..maxNrofCSI-SSB-ResourcePerSet) ) OF SSB- |
| Index, | | |
| ... | | |
| [[ | | |
| servingAdditionalPCIList-r17 | | SEQUENCE (SIZE (1..maxNrofCSI-SSB-ResourcePerSet) ) OF |
| ServingAdditionalPCIIndex-r17 | OPTIONAL | -- Need R |

| | |
|---|---|
| ]] | |
| } | |
| ServingAdditionalPCIIndex-r17 ::= | INTEGER (0..maxNrofAdditionalPCI-r17) |

CSI-SSB-ResourceSet field descriptions

servingAdditionalPCIList
Indicates the physical cell IDs (PCI) of the SSBs in the csi-SSB-ResourceList. If present, the list has the same number
of entries as csi-SSB-ResourceList. The first entry of the list indicates the value of the PCI for the first entry of csi-SSB-
ResourceList, the second entry of this list indicates the value of the PCI for the second entry of csi-SSB-ResourceList,
and so on. For each entry, the following applies:
If the value is zero, the PCI is the PCI of the serving cell in which this CSI-SSB-ResourceSet is defined;
otherwise, the value is additionalPCIIndex-r17 of an SSB-MTC-AdditionalPCI-r17 configured using the additionalPCI-
ToAddModList-r17 in ServingCellConfig, and the PCI is the additionalPCI-r17 in this SSB-MTC-AdditionalPCI-r17.

### ServingCellConfig

The IE ServingCellConfig is used to configure (add or modify) the UE with a serving cell, which may be the SpCell or an SCell of an MCG or SCG. The parameters herein are mostly UE specific but partly also cell specific (e.g. in additionally configured bandwidth parts). Reconfiguration between a PUCCH and PUCCHless SCell is only supported using an SCell release and add.

### ServingCellConfig Information Element

| | |
|---|---|
| ... | |
| MIMOParam-r17 ::= SEQUENCE { | |
| additionalPCI-ToAddModList-r17 | SEQUENCE (SIZE (1..maxNrofAdditionalPCI-r17)) OF SSB-MTC- |
| AdditionalPCI-r17 OPTIONAL, -- Need N | |
| additionalPCI-ToReleaseList-r17 | SEQUENCE (SIZE (1..maxNrofAdditionalPCI-r17)) OF |
| AdditionalPCIIndex-r17 OPTIONAL, | -- Need N |
| unifiedTCI-StateType-r17 | ENUMERATED {separate, joint} |
| OPTIONAL, -- Need R | |
| uplink-PowerControlToAddModList-r17 | SEQUENCE (SIZE (1..maxUL-TCI-r17)) OF Uplink-powerControl- |
| r17 OPTIONAL, -- Need N | |

uplink-PowerControlToReleaseList-r17 SEQUENCE (SIZE (1..maxUL-TCI-r17)) OF Uplink-powerControlId-

| | |
|---|---|
| r17 OPTIONAL, -- Need N | |
| sfnSchemePDCCH-r17 | ENUMERATED {sfnSchemeA, sfnSchemeB} |
| OPTIONAL, -- Need R | |
| sfnSchemePDSCH-r17 | ENUMERATED {sfnSchemeA, sfnSchemeB} |
| OPTIONAL -- Need R | |
| } | |

ServingCellConfig field descriptions

additionalPCI-ToAddModList
List of information for the additional SSB with different PCI than the serving cell PCI. The additional SSBs with different
PCIs are not used for serving cell quality derivation.

### SSB-MTC

The IE SSB-MTC is used to configure measurement timing configurations, i.e., timing occasions at which the UE measures SSBs.

### SSB-MTC Information Element

| | |
|---|---|
| ... | |
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, ms80, ms160, spare2, |
| spare1 }, | |
| ssb-PositionsInBurst-r17 | CHOICE { |
| shortBitmap | BIT STRING (SIZE (4)), |
| mediumBitmap | BIT STRING (SIZE (8)), |
| longBitmap | BIT STRING (SIZE (64)) |
| }, | |
| ss-PBCH-BlockPower-r17 | INTEGER (−60..50) |
| } | |
| AdditionalPCIIndex-r17 ::= | INTEGER (1..maxNrofAdditionalPCI-r17) |

SSB-MTC-AdditionalPCI field descriptions

additionalPCI
PCI of the additional SSB different from serving cell PCI.
periodicity
Periodicity of the SS/PBCH blocks, see 5.5.2.10. Periodicity is given in number of subframes.
ssb-PositionsInBurst
Indicates the time domain positions of the transmitted SS-blocks in a half frame with SS/PBCH blocks as defined in TS
38.213 [13], clause 4.1. The first/leftmost bit corresponds to SS/PBCH block index 0, the second bit corresponds to
SS/PBCH block index 1, and so on. Value 0 in the bitmap indicates that the corresponding SS/PBCH block is not
transmitted while value 1 indicates that the corresponding SS/PBCH block is transmitted.
ss-PBCH-BlockPower
Average EPRE of the resources elements that carry secondary synchronization signals in dBm that the NW used for
SSB transmission, see TS 38.213 [13], clause 7.

### TCI-State

The IE TCI-State associates one or two DL reference signals with a corresponding quasi-colocation (QCL) type.

### TCI-State Information Element

| | |
|---|---|
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ..., | |
| [[ | |
| additionalPCI-r17 | AdditionalPCIIndex-r17 |
| OPTIONAL, -- Need R | |
| pathlossReferenceRS-Id-r17 | PathlossReferenceRS-Id-r17 |
| OPTIONAL, -- Cond JointTCI1 | |
| ul-powerControl-r17 | Uplink-powerControlId-r17 |
| OPTIONAL, -- Cond JointTCI1 | |
| ]] | |
| } | |
| ... | |

TCI-State field descriptions

additionalPCI
Indicates the physical cell IDs (PCI) of the SSBs when referenceSignal is configured as SSB for both QCL-Type1 and
QCL-Type2. In case the cell is present, the additionalPCI refers to a PCI value configured in the list configured using
additionalPCI-ToAddModList in the serving cell indicated by the field cell. Otherwise, it refers to a PCI value configured
in a list additionalPCI-ToAddModList configured in the serving cell where the TCI-State is applied by the UE. When this
field is present the cell for qcl-Type1 and qcl-Type2 is configured with same value, if present.

### TCI-UL-State

The IE TCI-UL-State indicates the TCI state information for UL transmission.

### TCI-UL-State Information Element

| TCI-UL-State-r17 ::= | SEQUENCE { | |
|---|---|---|
| tci-UL-StateId-r17 | TCI-UL-StateId-r17, | |
| servingCellId-r17 | ServCellIndex | OPTIONAL, |
| -- Need R | | |
| bwp-Id-r17 | BWP-Id | OPTIONAL, |
| Cond CSI-RSorSRS-Indicated | | |
| referenceSignal-r17 | CHOICE { | |
| ssb-Index-r17 | SSB-Index, | |
| csi-RS-Index-r17 | NZP-CSI-RS-ResourceId, | |
| srs-r17 | SRS-ResourceId | |
| }, | | |
| additionalPCI-r17 | AdditionalPCIIndex-r17 | OPTIONAL, |
| -- Need R | | |
| ul-powerControl-r17 | Uplink-powerControlId-r17 | OPTIONAL, |
| -- Need R | | |
| pathlossReferenceRS-Id-r17 | PathlossReferenceRS-Id-r17 | OPTIONAL, |
| -- Cond Mandatory | | |
| ... | | |
| } | | |

TCI-UL-State field descriptions

additionalPCI
Indicates the physical cell IDs (PCI) of the SSBs when referenceSignal is configured as SSB. In case the servingCellId
is present, the additionalPCI refers to a PCI value configured in the list configured using additionalPCI-ToAddModList in
the serving cell indicated by the field servingCellId. Otherwise, it refers to a PCI value configured in the list configured
using additionalPCI-ToAddModList in the serving cell where the ul-TCI-StateList is applied by the UE.

In New WID on NR further mobility enhancements ([3] RP-212710 New WID on NR further mobility enhancements), objectives for enhancement on mobility for NR are discussed:

### 3 Justification

When the UE passes from the coverage area of one cell to another cell, at some point a serving cell change need to be performed. Currently serving cell change is triggered by L3 measurements and is done by RRC signalling triggered Reconfiguration with Synch for change of PCell and PSCell, as well as release add for SCells when applicable, all cases with complete L2 (and L1) resets, and involving more latency, more overhead and more interruption time than beam switch mobility. The goal of L1/L2 mobility enhancements is to be able to do serving cell change via L1/L2 signalling with such low latency, low overhead and low interruption time.

### 4 Objective

### 4.1 Objective of Core Part WI

The detailed objective of this work item are:
To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signalling [RAN2, RAN1]
   L1 enhancements, including inter-cell beam management, L1 measurement and reporting, beam indication, and for non-synchronized scenario to handle TA management [RAN1, RAN2]
   CU-DU interface signaling to support L1/L2 mobility, if needed [RAN3]

In 3GPP spec 38.300 running CR for introduction of NR further mobility enhancements ([4] R2-2213332 38.300 running CR for introduction of NR further mobility enhancements), L1/L2-triggered mobility (LTM) is introduced:

### 9.2.3.x L1/L2-Triggered Mobility

### 9.2.3.x.1 General

LTM is a procedure in which a gNB receives L1 measurement reports from UEs, and on their basis the gNB changes UEs' serving cell(s) through MAC CE. The gNB prepares one or multiple candidate cells and provides the candidate cell configurations to the UE through RRC message. Then LTM cell switch is triggered, by selecting one of the candidate configurations as target configuration for LTM by the gNB. The candidate cell configurations can only be added, modified and released by network via RRC signaling.

Editors' note: FFS later whether some optimization should be applied e.g. for release.

Editor's note: Current options to configure a LTM candidate cell:
a. One RRCReconfiguration message for candidate target cell
b. One CellGroupConfig IE for each candidate target cell

The following principles apply to LTM:
Candidate cell configuration can be provided as delta configurations on top of a reference configuration. The reference configuration is managed separately, and a UE stores the reference configuration as a separate configuration.
User plane is continued whenever possible (e.g. intra-DU), without reset, with the target to avoid data loss and the additional delay of data recovery.
   Security is not updated in LTM.
   Subsequent LTM between candidates (i.e., UE does not release other candidate cell configurations after LTM is triggered) can be performed without RRC reconfiguration.

LTM supports both intra-gNB-DU and intra-gNB-CU inter-gNB-DU mobility. LTM also supports inter-frequency mobility, including mobility to inter-frequency cell that is not a current serving cell. The following scenarios are supported:
PCell change in non-CA scenario,
PCell change without SCell change in CA scenario,
PCell change with SCell change(s) in CA scenario, including the following cases:
   a) The target PCell/target SCell(s) is not a current serving cell (CA-to-CA scenario with PCell change)
   b) The target PCell is a current SCell
   c) The target SCell is the current PCell.
Dual connectivity scenario, at least for the PSCell change without MN involvement case, i.e. intra-SN.

Inter-cell beam management is also supported, but is not considered as a prerequisite for using LTM.

Editor's note: The design for intra-DU and inter-DU L1/L2-based mobility should share as much commonality as reasonable. FFS which aspects need to be different.

Editor's note: FFS whether ASN.1 decoding and validity/compliance check of candidate cell configuration are performed upon reception of the candidate cells configuration, and if this needs to be specified.

### 9.2.3.x.2 C-Plane Handling

Cell switch trigger information is conveyed in a MAC CE, which contains at least a candidate configuration index. Cell-specific, radio bearer, and measurement configurations can be part of an LTM candidate cell configuration.

Editor's note: FFS if the MAC CE can indicate TCJ state(s) (or other beam info) to be activate for the target Cell(s) Editor's note: FFS if it should be possible to perform SCell activation/deactivation (amongst SCells associated with the candidate configuration) simultaneously with the LTM triggering MAC CE.

UE may perform CBRA or CFRA at cell switch. UE may also skip random access procedure if UE doesn't need to acquire TA for the target cell during cell switch. RACH resources for CFRA are provided in RRC configuration.

Editor's note: FFS if the CFRA resources can be provide via MAC CE.

The overall procedure for LTM is shown in Figure x below. Subsequent LTM is done by repeating the early synchronization, LTM execution, and LTM completion steps without releasing other candidates after each LTM completion.

FIG. 6 is a Reproduction of Figure x: Signaling Procedure for LTM, from R2-2213332 38.300.

The procedure for LTM is as follows.
1. The UE sends a MeasurementReport message to the gNB. The gNB decides to use LTM and initiates LTM candidate preparation.
The gNB transmits an RRCReconfiguration message to the UE including the configuration of one or multiple LTM candidate target cells.
3. The UE stores the configuration of LTM candidate target cell(s) and transmits a RRCReconfigurationComplete message to the gNB.
4. The UE may perform DL synchronization and TA acquisition with candidate target cell(s) before receiving the LTM cell switch command.

Editor's note: DL synchronization for candidate cell(s) before cell switch command is supported, at least based on SSB. FFS necessary mechanism.

Editor's note: TA acquisition of candidate cell(s) before LTM cell switch command is supported, at least based on PDCCH ordered RACH, where the PDCCH order is only triggered by source cell. FFS detailed mechanism.
5. The UE performs L1 measurements on the configured LTM candidate target cell(s), and transmits lower-layer measurement reports to the gNB.
6. The gNB decides to execute LTM cell switch to a target cell, and transmits a MAC CE triggering LTM cell switch by including the candidate configuration index of the target cell. The UE switches to the configuration of the LTM candidate target cell.

Editor's note: FFS how beam indication is done.
7. The UE performs random access procedure towards the target cell, if TA is not available.
8. The UE indicates successful completion of the LTM cell switch towards target cell. uplink signal or message after the UE has switched to the target cell is used to indicate successful completion of the LTM cell switch.

### 9.2.3.x.3 U-Plane Handling

In LTM, whether the UE performs partial or full MAC reset, re-establish RLC, performs data recovery with PDCP during cells with is explicitly controlled by the network.

Editor's note: ON the determination of whether to reset L2: two options on the table:
1) The UE determines whether the switch is intra DU or inter DU and the follows different rule or configuration for these two cases which controls whether to reset or not reset. Determination could be based on configuration (e.g. of a DU ID, cell group id etc)
2) The UE receives command to reset or not reset by MAC CE.

Editor's note: FFS what partial reset is.

Editor's note: For UE processing, the following (not exhaustive) is assumed to be performed after receiving the cell switch command:
1. MAC/RLC reset (when configured)
2. RF retuning (e.g. needed for inter-frequency), baseband retuning

Editor's note: FFS how the UE determine the BWPs (for DL and UL) to be used upon the execution of L1/L2 inter-cell mobility.

In 3GPP RAN1 #110b-e meeting ([5] 3GPP RAN1 #110b report), following agreements have been made regarding obtaining TA for candidate cells before LTM:

### Agreement

Support TA acquisition of candidate cell(s) before cell switch command is received in L1/L2 based mobility.
FFS: whether this can be applied to candidate cell when it is deactivated SCell (if defined in RAN2).

### From Oct 19th GTW Session

### Agreement

On mechanism to acquire TA of the candidate cells, the following solutions can be further studied:
RACH-based solutions
   e.g., PDCCH ordered RACH, UE-triggered RACH, higher layer triggered RACH from NW other than L3 HO cmd
RACH-less solutions
   e.g., SRS based TA acquisition, Rx timing difference based, RACH-less mechanism as in LTE, UE based TA measurement (including UE based TA measurement with one TAC from serving cell)

### Agreement

For TA acquisition of a candidate cell before cell switch command is received, study at least the following alternatives of associating TA/TAG to candidate cell:
Alt1: Associate TA/TAG and candidate cell implicitly, e.g.,
   the association between TA/TAG and TCI states can be configured
Alt2: Associate TA/TAG and candidate cell explicitly, e.g.,
   the association is provided as a part of candidate cell(s) configuration
   the association between TA/TAG and SSB(s)/TRS(s) is provided as a part of candidate cell(s) configuration

In 3GPP RAN1 #112 meeting ([6] 3GPP RAN1 #112 report), agreement has been made regarding PDCCH ordered-RACH for candidate cell(s):

### Agreement

For PDCCH ordered-RACH for candidate cell(s), RAR reception can be configured/indicated
If reception of RAR is not configured/indicated (without RAR)
   TA value of candidate cell is indicated in cell switch command
   FFS: whether UE should re-transmit PRACH when reception of RAR is not configured/indicated
   FFS: how UE determine the transmit power of subsequent PRACH triggered by PDCCH order
If reception of RAR is configured/indicated (with RAR), FFS
   whether RAR is received from-serving cell or candidate cell
      if RAR is received from candidate cell, whether Type1-PDCCH CSS of the candidate cell is configured to the UE
   content of RAR
FFS: signaling for configuration/indication of whether RAR needs to be received
UE can report the support combination of with RAR only and without RAR only, where support of one default scheme is the baseline UE approach for LTM
Send LS to RAN2 and RAN3 to check the feasibility about this agreement
Note: Definition of candidate cells is up to RAN2

### Agreement

For PDCCH-order based RACH for TA measurement for candidate cells, legacy CBRA is not supported

### Agreement

On whether UE should initiate re-transmit PRACH when reception of RAR is not configured/indicated, down select one from the following alternatives.
Alt 1: UE autonomous re-transmission of PRACH is not allowed (e.g., by setting the number of allowed PRACH transmission to the minimum value of PreambleTransMax=1)
Alt 2: UE autonomous Re-transmission of PRACH is allowed,
   The number of PRACH transmission will be defined e.g. set the times of RACH transmission to the minimum value of PreambleTransMax

### Agreement

If reception of RAR is configured/indicated, RAR contains at least TA of candidate cell.
The maximum number of TA values memorized by UE is a UE capability
FFS: whether other parameters such as UE ID, candidate cell ID etc. is contained in RAR

### Agreement

Whether RAR needs to be received is configured by RRC.

In RAN2 #121b is meeting ([7] 3GPP RAN2 #121b is report), agreements have been made regarding LTM:
From RAN2 perspective, to enable shared preamble resource among multiple UEs, it is beneficial that the information that identifies the allocated CFRA resource (i.e., SS/PBCH index, RACH occasion, and Random Access Preamble index) can be indicated in the PDCCH order (as legacy intra-cell PDCCH order).
RRC RACH configuration for early TA acquisition (e.g., including whether RAR needs to be received) is specific per target cell and is signalled separately (separate IEs) from the candidate cell configuration (the part that need to be applied at cell switch).
R2 assumes that Early TA RACH option 3 (with RAR from candidate cell) is not needed in Rel-18.
R2 assumes RRCReconfigurationComplete message is always sent at each LTM execution.
In RACH-based LTM, the target cell is aware of the UE's arrival based on the reception of preamble in CFRA and on the reception of Msg3/MsgA in CBRA, like the legacy HO.
In RACH-less LTM, the target cell is aware of the UE's arrival based on reception of the first UL transmission from this UE.
In RACH-less LTM, RRCReconfigurationComplete can be the content of the first UL MAC PDU/transmission to indicate UE arrival, i.e. no need to introduce any new signaling to indicate UE arrival (for the MCG-switch case).
For RACH-based LTM, the UE considers that LTM execution procedure is successfully completed when the RACH is successfully completed.
For RACH-less LTM, the UE considers that LTM execution procedure is successfully complete when the UE determines the NW has successfully received its first UL data.
Following behaviors of LTM supervisor timer are agreed:
   1: The UE starts the LTM supervisor timer, upon reception of the LTM cell switch MACCE;
   2: The UE stops the LTM supervisor timer, upon successful completion of LTM cell switch;
   3: If the LTM supervisor timer for MCG expires, as baseline, the UE considers LTM failure and initiates RRC re-establishment. (SCG switch case FFS).
LTM supervisor timer is RRC layer timer.
At RLF or LTM execution failure (for MCG), RAN2 intend to support fast recovery to a candidate cell by LTM execution.
While configured with LTM candidate cells, the UE can also execute any L3 handover command sent by the network. R2 assumes that is could be up to the network to avoid any issue due to the race condition between LTM execution and RRC Reconfiguration (e.g. L3 HO cmd), e.g. avoid sending LTM switch cmd and L3 HO cmd in the same TB.

In 3GPP RAN2 #122 meeting ([8] 3GPP RAN2 #122 report), an agreement was made regarding TA maintenance for candidate Cells for LTM:
Dynamic grant can be used for RACH-less LTM, for the first UL data transmission to the target cell:
the UE monitors PDCCH for dynamic scheduling from the target cell, upon LTM cell switch.
upon cell switch decision, R2 assumes that the source DU informs the target DU about the selected beam, so that the target DU can start scheduling dynamic UL grant.
Configured grant can be used for RACH-less LTM, for the first UL data transmission to the target cell, the UE selects the configured grant occasion, which is associated with the beam indicated in the LTM MAC CE (as set by source cell). FFS further optimization.
If the TA maintenance etc for candidate cell(s) in the UE is needed, the TA(s) associated with candidate cell(s) can be maintained during LTM (TDB exactly which cells decide stage-3).

In Work item for MIMO Evolution for Downlink and Uplink ([9] RP-223276 WID Update: MIMO Evolution for Downlink and Uplink), multi-panel UL transmission for Two TA multi-TRP operation is introduced:

### 4 Objective

### 4.1 Objective of SI or Core Part WI or Testing Part WI

The detailed objectives are as follows:

### RAN1:

[ . . . ]
2. Specify extension of Rel-17 Unified TCI framework for indication of multiple DL and UL TCI states focusing on multi-TRP use case, using Rel-17 unified TCI framework.
[ . . . ]
6. Study, and if needed, specify the following items to facilitate simultaneous multi-panel UL transmission for higher UL throughput/reliability, focusing on FR2 and multi-TRP, assuming up to 2 TRPs and up to 2 panels, targeting CPE/FWA/vehicle/industrial devices (if applicable)
   UL precoding indication for PUSCH, where no new codebook is introduced for multi-panel simultaneous transmission
      The total number of layers is up to four across all panels and total number of codewords is up to two across all panels, considering single DCI and multi-DCI based multi-TRP operation.
   UL beam indication for PUCCH/PUSCH, where unified TCI framework extension in objective 2 is assumed, considering single DCI and multi-DCI based multi-TRP operation
      For the case of multi-DCI based multi-TRP operation, only PUSCH+PUSCH, or PUCCH+PUCCH is transmitted across two panels in a same CC.
7. Study, and if justified, specify the following
   Two TAs for UL multi-DCI for multi-TRP operation
   Power control for UL single DCI for multi-TRP operation where unified TCI framework extension in objective 2 is assumed.

For the case of simultaneous UL transmission from multiple panels, the operation will only be limited to the objective 6 scenarios.

In 3GPP specification 38.211 ([10] 3GPP 38.211 v17.1.0), timing advance is introduced:
N_{TA} Timing advance between downlink and uplink; see clause 4.3.1
N_{TA,offset} A fixed offset used to calculate the timing advance; see clause 4.3.1

### 4.3.1 Frames and Subframes

Downlink, uplink, and sidelink transmissions are organized into frames with T_{f}=(Δfₘₐₓ N_{f}/100)·T_{c}=10 ms duration, each consisting of ten subframes of T_{sf}=(Δfₘₐₓ N_{f}/1000)·T_{c}=1 ms duration. The number of consecutive OFDM symbols per subframe is N_{symb}^{subframe,μ}=N_{symb}^{slot}Nₛₗₒₜ^{subframe,μ}. Each frame is divided into two equally-sized half-frames of five subframes each with half-frame 0 consisting of subframes 0-4 and half-frame 1 consisting of subframes 5-9.

There is one set of frames in the uplink and one set of frames in the downlink on a carrier.

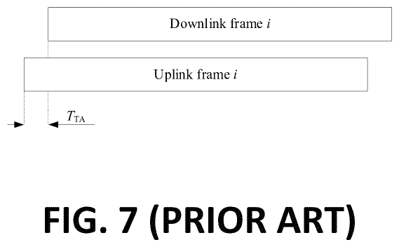

Uplink frame number i for transmission from the UE shall start T_{TA}=(N_{TA}+N_{TA,offset}+N_{TA,adj}^{common}+N_{TA,adj}^{UE}) T_{c} before the start of the corresponding downlink frame at the UE where
N_{TA} and N_{TA,offset} are given by clause 4.2 of [5, TS 38.213], except for msgA transmission on PUSCH where N_{TA}=0 shall be used;
N_{TA,adj}^{common} is derived from the higher-layer parameters TACommon, TACommonDrift, and TACommonDriftVariation if configured, otherwise N_{TA,adj}^{common}=0;
N_{TA,adj}^{UE} is computed by the UE based on UE position and serving-satellite-ephemeris-related higher-layers parameters if configured, otherwise N_{TA,adj}^{UE}=0.
   FIG. 7 is a Reproduction of Figure 4.3.1-1: Uplink-Downlink Timing Relation, from 3GPP 38.211 v17.1.0.

In RAN2 #123 meeting ([11] R2-2308972 Report from NR MIMO evolution session), agreements regarding random access procedure for additionalPCI is introduced:

### Working Assumption:

We will use the 2-PTAG model, i.e., both TAGs of SpCell are PTAGs;
   When the TAT for STAG is expired and the other TAT is running for a serving cell (i.e., SCell), no impact to the TRP with running TAT; 1 and 7 are applied to the TRP with TAT expired, FFS whether 2-6 are applied to the TRP with TAT expired,
   when the TAT for PTAG is expired and the other TAT is running for a serving cell (SpCell or SCell), no impact to the TRP with running TAT; 1 and 7 are applied to the TRP with TAT expired, FFS whether 2-6 are applied to the TRP with TAT expired.
For inter-cell PDCCH order CFRA to the additionalPCI,
   PDCCH order indicates which additionalPCI's PRACH configuration to be used (according to RAN1 agreement),

In New Radio (NR), a User Equipment (UE) performs a handover procedure to switch from one cell (e.g., a source Cell) to another cell (e.g., a target Cell). The UE performs the handover procedure in response to a Radio Resource Control (RRC) signaling transmitted by a network. The RRC signaling contains cell information of a target cell. The network determines to initiate the handover procedure based on measurement reports of the UE. Change of Primary Cell (PCell) and Primary Secondary Cell (PSCell) (Primary Cell of a Secondary Cell Group (SCG)) via reconfiguration with sync (e.g., involving Layer-3 RRC message) involves high latency and more overhead than L1/L2 signaling (e.g., beam switch mobility). In addition, in operation on FR2, frequent SCG changes will occur, which could also lead to high latency for UE-Network (NW) communication if L3 Handover is used. Therefore, in Work Item Description (WID) for NR mobility enhancements ([3] RP-212710 New WID on NR further mobility enhancements), an objective of the work item is to specify mechanism and procedure (e.g., an L1/L2-triggered Mobility (LTM) procedure) for dynamic switching mechanism among serving cells, including Special Cell(s) (SpCell(s)) and/or Secondary Cell(s) (SCell(s)) based on L1/L2 signaling. The serving cells could include a target Cell of the LTM procedure and one or more SCell(s) (to be added or released) in the LTM procedure. An LTM procedure could consist of a Next Generation Node B (gNB) of a source Cell providing a first information and a second information. The first information could contain or indicate candidate cell information (e.g., candidate cell configuration) (via an RRC message). The first information could contain or indicate one or more RRC reconfiguration messages associated with one or more candidate cell(s) (or candidate cell group(s)). For example, the first information could contain or indicate cell configurations and/or Random Access Channel (RACH) configurations for the one or more candidate cell(s). The first information could contain one or more RRC reconfiguration message, each for a candidate (cell) configuration associated with a candidate cell. The second information may not be an RRC or L3 message (e.g., could contain a Physical Downlink Control Channel (PDCCH) and/or a Medium Access Control (MAC) Control Element (CE)), and could indicate the UE to perform an LTM procedure to a candidate cell (group) (in the one or more candidate cell(s) in the first information). The second information could be a an LTM switch command or a Cell switch command (e.g., a Downlink Control Indicator/Indication (DCI) and/or a MAC CE). The candidate cell(s) could be target Cell(s) of the LTM procedure. Each of the one or more candidate cell(s) could be associated with an identity or index (e.g., candidate index). The second information could indicate the candidate index of the candidate cell.

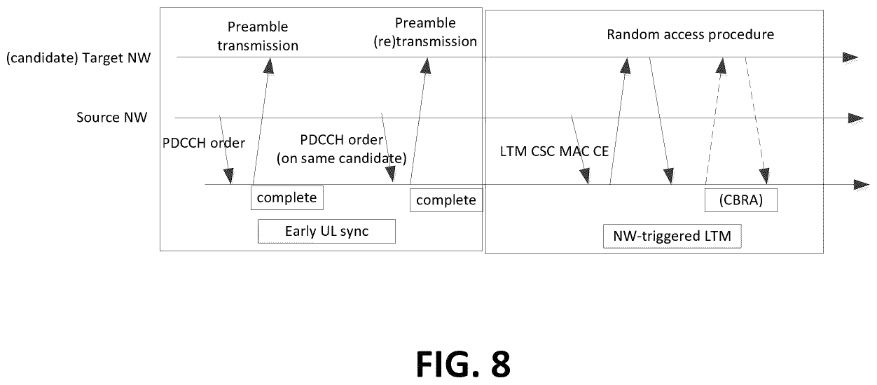

For LTM, both a RACH-based and a RACH-less LTM will be supported. For a RACH-based LTM, the UE initiates/performs a random access procedure to a target Cell in an LTM procedure (in response to receiving a cell switch command to switch to the target cell). The right part of FIG. 8 is an example.

For a RACH-less LTM, the UE may not initiate or perform a random access procedure to a target Cell in response to receiving a cell switch command (MAC CE) for switching to the target Cell. The UE could obtain a TA associated with the target Cell via an early TA acquisition procedure on candidate cell(s) including the target Cell. The early TA acquisition could include or contain the UE initiating a random access procedure or performing a random access preamble transmission on a target cell (before receiving a cell switch command to the target cell). The left part of FIG. 8 is an example. The UE could obtain a TA associated with the target cell in response to completion of the early TA acquisition. Alternatively, the UE may not obtain the TA associated with the target cell, and the network could store the TA (and indicate to the UE in Cell switch command(s)). In such a case, the UE does not know whether the random access procedure for early TA acquisition is successful or not due to absence of a Random Access Response (RAR) reception.

Additionally and/or alternatively, the network may not provide or transmit a cell switch command to the UE to initiate an LTM to a candidate cell. The UE could determine to initiate an LTM procedure switching to the candidate cell based on a condition (e.g., conditional LTM).

In NR, multi-Transmission/Reception Point (mTRP) operation is introduced. A UE could perform Downlink (DL) and/or Uplink (UL) transmission on different TRP(s) (via different panels) of a same Cell (intra-Cell mTRP) or different Cells (inter-Cell mTRP). For inter-Cell mTRP, the UE could be configured with one or more non-serving Cell(s) associated with a Serving Cell. A non-serving Cell(s) could be associated with an additional Physical Cell Identity (PCI) that is different from a PCI associated with any Serving Cell(s). In Rel-18 NR, two TAs for UL multi-DCI for multi-TRP operation is introduced. The UE could perform UL transmission on two different TRPs by applying different TA values or N_{T}A. The UE could perform inter-Cell or intra-Cell multi-TA mTRP operations. For inter-Cell mTRP, the UE could perform UL transmission on a first TRP associated with/on a Serving Cell and a second TRP associated with/on a non-serving Cell associated with/configured in the Serving Cell. When the UE does not have a valid TA information or a valid TA value of a TRP/UL, the UE could initiate a random access procedure on the TRP. Additionally and/or alternatively, the UE could be indicated by a network (e.g., via a PDCCH order) to perform/initiate a random access procedure on the TRP. The TRP could be associated with a non-serving Cell. The non-serving cell could be indicated by a PDCCH order and/or could be an active non-serving cell.

In NR Rel-16, Random Access (RA) information request and response is introduced. The UE could be indicated/requested by a network to report an RA report indicating random access information associated with random access procedures the UE initiated. In Rel-17, in order to have a network forward RA report(s) to correct other networks, the UE includes Master Cell Group (MCG)/SCG SpCell information in the RA-report.

In response to a successfully performed random access procedure, the UE could store or append an RA report containing random access information in a list of RA-Report (e.g., ra-ReportList). The RA report could contain a cell Identity (Id) associated with the random access procedure. The RA report could contain a purpose of the associated random access procedure. The RA report could contain ra-InformationCommon. The ra-InformationCommon could contain subcarrier spacing, frequency, and/or Channel State Information Reference Signal (CSI-RS) associated with the random access procedure. For random access procedures initiated for candidate cell(s) and/or for LTM and/or for non-serving cell(s), how to perform UE information reporting regarding the random access procedures is not defined. According to [2] 3GPP 38.331 v17.4.0, information for the random access procedure for early TA acquisition would not be stored/recorded because the UE cannot know whether the random access procedure for early TA acquisition is successful or not due to the absence of RAR reception. In addition, no existing raPurpose (without modification) is applicable for this case.

With the present invention, methods for handling RA reports for random access procedures associated with L1/L2-triggered mobility, and random access procedures associated with inter-Cell multi-TRP operations, are introduced, as detailed below.

### RA-Report

Case 1: RA for early TA acquisition.
Case 2: RA-based LTM (triggered by NW).
Case 3: RA-based conditional LTM.
For each case, whether to use existing purpose or introduce a new purpose.
For each case, whether to indicate spCellID or not.
For each case, content of RA-InformationCommon, e.g., whether perRAInfoList is needed for case 1 or not.
Successful handover report for LTM.
Case 4: inter-Cell mTRP RACH on additionalPCI
   Purpose: unsync UL or other
   Information:
      1. Indicate additionalPCI in cellID-r16/pci-arfcn, and indicate Serving Cell in SpCell ID or in another Information Element (IE).
      How to determine frequency in IE PCIarFcN for additionalPCI.
      2. Indicate Serving Cell in cellID-r16, and indicate additionalPCI in another IE (e.g., with an option/condition to indicate).
      Indicate index or phyid for the additionalPCI.

### For Each Case, Whether to Use Existing Purpose or Introduce a New Purpose

One concept of the present invention is that a UE could store a random access information (or a Random Access information, or an RA information) associated with a random access procedure (or a Random Access procedure, or an RA procedure) to a candidate cell. The UE could store a random access information associated with an early TA acquisition (before an LTM Cell switch command) on a candidate cell.

Additionally and/or alternatively, for a random access procedure to a candidate cell, the UE could set/indicate a purpose associated with the random access procedure in a random access information. The UE could determine which/what purpose to set/indicate based on at least the type of the random access procedure. The random access procedure could be initiated to perform on a RACH.

The candidate cell could be a target cell in an LTM procedure (in response to a cell switch command to the candidate cell or in response to a UE-initiated condition).

The candidate cell could be associated with a candidate configuration in an LTM configuration. The candidate cell could be an SpCell (e.g., PCell) of the candidate configuration.

The random access information could be an RA report (e.g., RA-Report-r16).

The UE could append the random access information associated with the random access procedure in response to successful completion of or successfully performing the random access procedure.

The UE could be indicated/requested by a network to report the random access information to the network. The UE could report a list of random access information (e.g., ra-ReportList) in response to the request. The network could transmit a UE information request (e.g., UEInformationRequest) to the UE to request the UE to report the random access information to the network.

### Case 1: RA for Early TA Acquisition

The type of the random access procedure to the candidate cell could be (associated with) for an early TA acquisition for the candidate cell. The random access procedure could be initiated by a PDCCH order. The random access procedure may not contain (monitoring or receiving) a RAR.

For the random access procedure to the candidate cell for early TA acquisition for the candidate cell, the UE could set/indicate the purpose as a first new purpose (e.g., ‘early TA acquisition’). The first new purpose may not be any one of ‘accessRelated’, ‘beamFailureRecovery’, ‘reconfigurationWithSync’, ‘ulUnSynchronized’, ‘schedulingRequestFailure’, ‘noPUCCHResourceAvailable’, ‘requestForOtherSI’, nor ‘msg3RequestForOtherSI-r17’.

Additionally and/or alternatively, for the random access procedure to the candidate cell for early TA acquisition for the candidate cell, the UE could set/indicate the purpose as ‘LTMRelated’.

The purpose, ‘LTMRelated’, could be applied to (all) random access procedures associated with a candidate cell. The purpose, ‘LTMRelated’, could indicate that the random access procedure is associated with a candidate cell and/or associated with an LTM procedure.

Additionally and/or alternatively, for the random access procedure to the candidate cell for early TA acquisition for the candidate cell, the UE could set/indicate the purpose as ‘accessRelated’.

Additionally and/or alternatively, for the random access procedure to the candidate cell for early TA acquisition for the candidate cell, the UE could set/indicate the purpose as ‘reconfigurationWithSync’.

Additionally and/or alternatively, for the random access procedure to the candidate cell for early TA acquisition for the candidate cell, the UE could set/indicate the purpose as ‘ulUnSynchronized’.

Without storing the random access information associated with the random access procedure for the early TA acquisition, the network cannot distinguish between RACH failures due to PDCCH order not received by the UE or RACH failures due to the preamble not received by the network. The network can precisely know whether to optimize the candidate cell RACH configuration or not (e.g., failure due to Serving Cell beam management) based on the random access information.

### Case 2: RA-Based LTM (Triggered by NW)

Additionally and/or alternatively, the type of the random access procedure to the candidate cell could be a (LTM) random access procedure to the candidate cell in response to receiving a (LTM) cell switch command from the network. The UE could determine whether to initiate a random access procedure to the candidate cell in response to receiving the (LTM) cell switch command based on at least whether the UE has/maintains/stores a valid TA information associated with the candidate cell. The UE could determine to initiate a random access procedure to the candidate cell in response to receiving the (LTM) cell switch command if or when the UE does not have/maintain/store a valid TA information associated with the candidate cell. The UE may not initiate a random access procedure to the candidate cell in response to receiving the (LTM) cell switch command if or when the UE has/maintains/stores a valid TA information associated with the candidate cell.

For the random access procedure to the candidate cell in response to receiving the (LTM) cell switch command, the UE could set/indicate the purpose as a second new purpose (e.g., ‘NWtriggeredLTM’). The second new purpose may not be any one of ‘accessRelated’, ‘beamFailureRecovery’, ‘reconfigurationWithSync’, ‘ulUnSynchronized’, ‘schedulingRequestFailure’, ‘noPUCCHResourceAvailable’, ‘requestForOtherSI’, nor ‘msg3RequestForOtherSI-r17’.

For the (LTM) random access procedure to the candidate cell in response to receiving a (LTM) cell switch command from the network, the UE could set/indicate the purpose as ‘NWtriggeredLTM’. The purpose set for the LTM random access procedure in response to receiving a (LTM) cell switch command may not be the same as the purpose set for an LTM random access procedure initiated by the UE (itself, based on a condition).

Additionally and/or alternatively, for the (LTM) random access procedure to the candidate cell in response to receiving an LTM cell switch command from the network, the UE could set/indicate the purpose as ‘LTMRelated’.

The purpose, ‘LTMRelated’, could be applied to (all) random access procedures associated with a candidate cell.

Additionally and/or alternatively, for the random access procedure to the candidate cell in response to receiving a (LTM) cell switch command from the network, the UE could set/indicate the purpose as ‘accessRelated’.

Additionally and/or alternatively, for the random access procedure to the candidate cell in response to receiving a (LTM) cell switch command from the network, the UE could set/indicate the purpose as ‘reconfigurationWithSync’.

Additionally and/or alternatively, for the random access procedure to the candidate cell in response to receiving a (LTM) cell switch command from the network, the UE could set/indicate the purpose as ‘ulUnSynchronized’.

### Case 3: RA-Based Conditional LTM

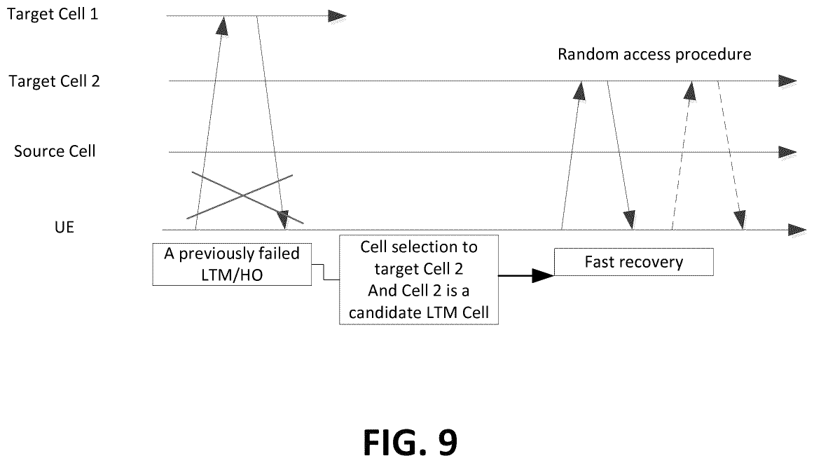

Additionally and/or alternatively, the type of the random access procedure could be a (LTM) random access procedure to the candidate cell initiated by the UE (itself, based on a condition). FIG. 9 is an example. The UE may not receive a (LTM) cell switch command associated with or indicating the candidate cell from the network (before initiating the random access procedure to the candidate cell). The UE could determine whether to initiate a random access procedure to the candidate cell in response to the condition being met based on at least whether the UE has/maintains/stores a valid TA information associated with the candidate cell. The UE could determine to initiate a random access procedure to the candidate cell in response to the condition being met if or when the UE does not have/maintain/store a valid TA information associated with the candidate cell. The UE may not initiate a random access procedure to the candidate cell in response to the condition being met if or when the UE has/maintains/stores a valid TA information associated with the candidate cell.

For the random access procedure to the candidate cell initiated by the UE (itself, based on a condition), the UE could set/indicate the purpose as a third new purpose (e.g., ‘UEtriggeredLTM’). The third new purpose may not be any one of ‘accessRelated’, ‘beamFailureRecovery’, ‘reconfigurationWithSync’, ‘ulUnSynchronized’, ‘schedulingRequestFailure’, ‘noPUCCHResourceAvailable’, ‘requestForOtherSI’, nor ‘msg3RequestForOtherSI-r17’.

Additionally and/or alternatively, for the (LTM) random access procedure to the candidate cell initiated by the UE, the UE could set/indicate the purpose as ‘LTMRelated’.

The purpose, ‘LTMRelated’, could be applied to (all) random access procedures associated with/to a candidate cell.

Additionally and/or alternatively, the first, second, and third new purposes are the same.

Additionally and/or alternatively, the second and the third new purposes are the same. The second and the third new purposes could be different from the first new purpose.

Additionally and/or alternatively, for the random access procedure to the candidate cell initiated by the UE (itself, based on a condition), the UE could set/indicate the purpose as ‘accessRelated’.

Additionally and/or alternatively, for the random access procedure to the candidate cell initiated by the UE (itself, based on a condition), the UE could set/indicate the purpose as ‘reconfigurationWithSync’.

Additionally and/or alternatively, for the random access procedure to the candidate cell initiated by the UE (itself, based on a condition), the UE could set/indicate the purpose as ‘ulUnSynchronized’.

Additionally and/or alternatively, the UE could set/indicate a same purpose for the random access procedure to the candidate cell initiated by the UE and the random access procedure to the candidate cell in response to receiving a (LTM) cell switch command from the network.

### Whether to Indicate SpCell ID

The UE could indicate a SpCell identity in the random access information. Additionally and/or alternatively, the UE could determine whether to indicate a SpCell identity (in the random access information) based on at least the type of the random access procedure.

The SpCell identity could be a (physical cell or global cell) id of a PCell (of MCG) (before an LTM procedure is completed) if or when the candidate cell is configured in a candidate configuration associated with the MCG. The SpCell identity could be a (physical cell or global cell) id of a SpCell (e.g., PSCell of SCG) (before LTM procedure is completed) if or when the candidate cell is configured in a candidate configuration associated with the SCG.

For example, the UE could indicate the SpCell identity if or when the type of the random access procedure is:
an early TA acquisition for the candidate cell; and/or
a (LTM) random access procedure to the candidate cell in response to receiving a (LTM) cell switch command from the network; and/or
a random access procedure to the candidate cell initiated by the UE (itself, based on a condition).

Additionally and/or alternatively, the UE may not indicate the SpCell identity if or when the type of the random access procedure is:
an early TA acquisition for the candidate cell; and/or
a (LTM) random access procedure to the candidate cell in response to receiving a (LTM) cell switch command from the network; and/or
a random access procedure to the candidate cell initiated by the UE (itself, based on a condition).

For example, the UE could indicate the SpCell identity (associated with the candidate cell) in the random access information if or when the random access procedure is for early TA acquisition for the candidate cell. The UE may not indicate the SpCell identity (associated with the candidate cell) in the random access information if or when the random access procedure is an LTM random access procedure to the candidate cell (in response to receiving a (LTM) cell switch command from the network or initiated by the UE itself based on a condition).

For Each Case, Content of RA-InformationCommon, e.g., Whether perRAInfoList is Needed for Case 1 or not

Additionally and/or alternatively, the UE could determine whether to indicate or include one or more parameter(s) in the random access information based on at least the type of the random access procedure. Additionally and/or alternatively, the UE may not indicate or include the one or more parameter(s) in the random access information for random access procedure(s) for early TA acquisition for the candidate cell. Additionally and/or alternatively, the UE could indicate or include the one or more parameter(s) in the random access information for (any) random access procedure(s) (initiated) other than for early TA acquisition for candidate cell(s).

The one or more parameter(s) could be perRAInfoList. For example, the UE may not include the perRAInfoList if or when the random access procedure is an early TA acquisition for the candidate cell. The UE could include the perRAInfoList if or when the random access procedure is a (LTM) random access procedure to the candidate cell (in response to (LTM) cell switch command or initiated by the UE).

Additionally and/or alternatively, the one or more parameter(s) could be RA-InformationCommon.

Additionally and/or alternatively, the one or more parameter(s) could be contentionDetected.

Additionally and/or alternatively, the one or more parameter(s) could be dlRSRPAboveThreshold.

Additionally and/or alternatively, the one or more parameter(s) could be fallbackToFourStepRA.

Additionally and/or alternatively, there could be (only) one entry in perRAInfoList if or when the random access procedure is for early TA acquisition of the candidate cell.

Additionally and/or alternatively, the one or more parameter(s) could be numberOfPreamblesSentOnSSB.

The UE could (only) set a value of the one or more parameter(s) to ‘1’ if or when the random access procedure is for early TA acquisition. The value could be indicated in a PDCCH order initiating/triggering the random access procedure.

Additionally and/or alternatively, the UE may not include or append or store information associated with a random access procedure for early TA acquisition in a random access information. The UE may not report information associated with random access procedure for early TA acquisition in an RA-Report.

Additionally and/or alternatively, the UE could include or append or store information associated with a random access procedure for early TA acquisition in a random access information.

The UE could include or append or store information associated with one or more random access procedure(s) for early TA acquisition to a same candidate cell (in a same entry) in the (same) random access information. The UE could add or update the random access information (of a same candidate cell) in response to or for each random access procedure of the candidate cell. For example, information of retransmission of a random access preamble (or number of preamble transmission) to the candidate cell triggered by a following PDCCH order is stored in the same random access information (as a random access information storing information associated with a random access procedure with an initial preamble transmission on the candidate cell).

The information could include IE and/or parameter(s) in the RA-Report and/or in ra-InformationCommon.

Additionally and/or alternatively, the UE could include or append or store information for each random access procedure(s) for early TA acquisition to a same candidate cell in different random access information (or in different entries of the random access information).

The entry could be an entry in a VarRA-Report or ra-ReportList.

For example, the UE could receive a first PDCCH order indicating a first random access preamble transmission to a candidate cell (for early TA acquisition). The UE could receive a second PDCCH order indicating a second random access preamble transmission (e.g., retransmission) to the candidate cell (for early TA acquisition). The UE could include information of the first random access preamble transmission and information of the second random access preamble transmission in a same entry (e.g., same RA-report or same ra-InformationCommon (of same RA-report) or in different entries in the random access information. The first PDCCH order could indicate that power ramping for the first random access preamble transmission is not needed. The second PDCCH order could indicate that power ramping for the second random access preamble transmission is needed.

Indicate LTM Success in successHO-Report

Additionally and/or alternatively, the UE could store LTM procedure information associated with an LTM procedure in a report (in response to successful completion of the LTM procedure). For example, the UE could store LTM procedure information associated with an LTM procedure (e.g., the random access information) in the report in response to successful completion of a random access procedure associated with the LTM procedure. The LTM procedure could contain the UE switching of its SpCell (e.g., PCell) to the candidate cell (without RRC reconfiguration with sync).

The report could be a VarSuccessHO-Report. Alternatively, the report could be a different report than the VarSuccessHO-Report (e.g., a successLTM report).

The UE could be requested to transmit the report to the network in response to a request by the network.

The LTM procedure information could indicate a Cell Radio Network Temporary Identifier (C-RNTI) associated with the candidate cell.

The LTM procedure information could indicate a C-RNTI associated with a source cell (e.g., SpCell before the LTM procedure).

The LTM procedure information could indicate an LTM candidate configuration index.

The LTM procedure information may not indicate a PCell associated with a Reconfigurationwithsync.

The LTM procedure information could indicate a purpose or cause associated with the LTM procedure. For example, the purpose or cause could be ‘NW-initiated’ or ‘UE-initiated’.

The random access procedure may not be a random access procedure for early TA acquisition.

The report could be a list of (or one) LTM procedure information.

Case: Inter-Cell mTRP RACH on additional PCI

Additionally and/or alternatively, the type of the random access procedure could be a random access procedure on a non-serving cell. For a random access procedure on a non-serving cell, the UE could indicate parameter(s) and/or a purpose associated with the random access procedure in the random access information.

The random access procedure could be initiated by a PDCCH order. The PDCCH order could indicate a RACH configuration and/or RACH resource(s) associated with the non-serving cell. The PDCCH order could indicate the UE to perform a random access procedure on a non-serving cell (e.g., via a bit field or via a non-serving cell index). The non-serving cell could be associated with an additional PCI of a serving cell and/or associated with an additional PCI index of the serving cell.

Additionally and/or alternatively, the random access procedure could be initiated by the UE (itself). The UE could determine to initiate the random access procedure based on whether a TA is valid for a (activated) non-serving cell (when or if the UE is activated with the non-serving cell or the UE is indicated to perform an inter-cell mTRP operation with the non-serving cell).

The non-serving cell could be a Cell associated with a PCI different from (any of) serving cells configured for/associated with the UE. The non-serving cell could be associated with an additional PCI configured for/associated with a serving Cell of the UE.

The non-serving cell could be associated with a TRP. The non-serving cell could be an activated non-serving cell. The UE could perform inter-Cell multi-TRP (mTRP) operation on the non-serving cell (via the TRP) and the serving cell (associated with the non-serving cell).

The UE could maintain two (uplink) TAs, one for the non-serving cell and one for the serving cell.

For the random access procedure on a non-serving cell, the UE could set/indicate the purpose (in the random access information) as a first new purpose (e.g., ‘inter-cell mTRP related’ or ‘inter-cell multi-TA mTRP related’). The first new purpose may not be any one of ‘accessRelated’, ‘beamFailureRecovery’, ‘reconfigurationWithSync’, ‘ulUnSynchronized’, ‘schedulingRequestFailure’, ‘noPUCCHResourceAvailable’, ‘requestForOtherSI’, nor ‘msg3RequestForOtherSI-r17’.

Additionally and/or alternatively, for the random access procedure on the non-serving cell, the UE could set/indicate the purpose as ‘mTRP related’ or ‘inter-cell mTRP related’.

The purpose, ‘mTRP related’ or ‘inter-cell mTRP related’, could be applied to (all) random access procedures associated with a non-serving cell. The purpose, ‘mTRP related’ or ‘inter-cell mTRP related’, could indicate that the random access procedure is associated with inter-Cell multi-TRP operation.

Additionally and/or alternatively, for the random access procedure on the non-serving cell, the UE could set/indicate the purpose as ‘accessRelated’.

Additionally and/or alternatively, for the random access procedure on the non-serving cell, the UE could set/indicate the purpose as ‘ulUnSynchronized’.

The random access information could be an RA report (e.g., RA-Report-r16).

The UE could append the random access information associated with the random access procedure in response to successful completion or successfully performing of the random access procedure.

The UE could be indicated/requested by a network to report the random access information to the network. The UE could report a list of random access information (e.g., ra-ReportList) in response to the request. The network could transmit a UE information request (e.g., UEInformationRequest) to the UE to request the UE to report the random access information to the network.

Indicate Additional PCI in cellID (and Indicate Serving Cell in SpCell ID or in Another IE)

Additionally and/or alternatively, the UE could determine how to set content(s) associated with a cell id in the random access information based on the type of the random access procedure.

The UE could set one or more ID(s) associated with the non-serving cell if or when the random access procedure is a random access procedure on the non-serving cell. The UE could set the value of an additional PCI associated with the non-serving cell in a parameter or IE (e.g., cellId-r16 or cellGlobalId-r16 or pci-arfcn-r16 or physCellId-r16 in PCI-ARFCN-NR-r16) in the random access information. Additionally and/or alternatively, the UE could indicate, in the random access information, that the random access procedure is performed on the non-serving cell (e.g., via an optional parameter).

The UE could set the value of a frequency information (e.g., pci-arfcn-r16 or carrierFreq-r16 in PCI-ARFCN-NR-r16) in the random access information as a frequency of the non-serving cell or a frequency of a serving cell associated with the non-serving cell. The UE could perform inter-cell mTRP operation with (a first TRP on) the serving cell and (a second TRP on) the non-serving cell. Additionally and/or alternatively, the UE could indicate an index (e.g., AdditionalPCIIndex) associated with the non-serving cell in the random access information. The UE may not indicate a PCI associated with the non-serving cell.

Additionally and/or alternatively, the UE could indicate or include one or more ID(s) (e.g., PCI, or CGI-Info-Logging-r16 or identity(s) in CGI-Info-Logging) or an index (e.g., serving cell index) associated with the serving cell in the random access information (in addition to the parameter or IE indicating the additional PCI). Additionally and/or alternatively, for a random access procedure on the non-serving cell (configured for the serving cell), the UE could include or indicate the serving cell in the spCellID-r17.

If the serving cell is an SpCell, the UE could include or indicate the serving cell in the spCellID-r17 of the random access information.

If the serving cell is an SCell, the UE could include or indicate the serving cell in a new ID or parameter (in addition to the spCellID-r17) of the random access information. The SpCell of the SCell could be indicated in the spCellID-r17 of the random access information. Alternatively, the SpCell of the SCell may not be indicated in (the spCellID-r17 of) the random access information.

Indicate Serving Cell in cellID-r16, and Indicate additionalPCI in Another IE (e.g., with an Option/Condition)

Additionally and/or alternatively, the UE could set one or more ID(s) associated with the serving cell (associated with the non-serving cell) if or when the random access procedure is a random access procedure on the non-serving cell. The UE could set the value of the one or more ID(s) associated with the serving cell in a parameter or IE (e.g., cellId-r16 or cellGlobalId-r16 or physCellId-r16 in PCI-ARFCN-NR-r16) in the random access information. The UE could set the value of a frequency information (e.g., pci-arfcn-r16 or carrierFreq-r16 in PCI-ARFCN-NR-r16) in the random access information as a frequency of the serving cell associated with the non-serving cell. The UE could perform inter-cell mTRP operation with (a first TRP on) the serving cell and (a second TRP on) the non-serving cell. Additionally and/or alternatively, the UE could indicate an index (e.g., ServingCellIndex or ServCellIndex) associated with the serving cell in the random access information. The UE may not indicate a PCI associated with the serving cell.

Additionally and/or alternatively, the UE could indicate or include information (e.g., one or more ID(s) or an index) associated with the non-serving cell in the random access information (in addition to the parameter or IE indicating the cellID (of the serving cell)). The UE could determine whether to include an IE or a parameter in a random access information for a random access procedure based on whether the random access procedure is on a non-serving cell. The IE or the parameter could indicate information associated with the non-serving cell. For example, the IE or the parameter could indicate frequency and/or additional PCI of the non-serving cell. For another example, the IE or the parameter could indicate the serving cell associated with the non-serving cell. The UE may not indicate the IE or the parameter if or when the random access procedure is not performed on a non-serving cell.

Additionally and/or alternatively, for a random access procedure on the non-serving cell (configured for the serving cell), the UE could include or indicate the non-serving cell in the spCellID-r17.

Additionally and/or alternatively, the UE could indicate the SpCell identity (associated with the serving cell or non-serving cell) in the random access information if or when the random access procedure is on the non-serving cell. Alternatively, the UE may not indicate the SpCell identity (associated with the serving cell or non-serving cell) in the random access information if or when the random access procedure is on the non-serving cell.

If the serving cell is an SCell, the SpCell of the SCell could be indicated in the spCellID-r17 of the random access information. Alternatively, the SpCell of the SCell may not be indicated in (the spCellID-r17 of) the random access information.

Additionally and/or alternatively, the UE could indicate or include information (e.g., one or more ID(s) or an index) associated with the non-serving cell in RA-InformationCommon (in the random access information). The one or more ID(s) or an index could indicate the non-serving cell associated with one or more beam(s) (in the RA-InformationCommon) (e.g., Synchronization Signal Block (SSB) or CSI-RS) used for the random access procedure.

For Each Case, Content of RA-InformationCommon, e.g., Whether perRAInfoList is Needed

Additionally and/or alternatively, the UE could determine whether to indicate or include one or more parameter(s) in the random access information based on at least the type of the random access procedure. Additionally and/or alternatively, the UE may not indicate or include the one or more parameter(s) in the random access information for random access procedure(s) on the non-serving cell.

The one or more parameter(s) could be perRAInfoList. For example, the UE may not include the perRAInfoList if or when the random access procedure is on the non-serving cell.

Additionally and/or alternatively, the one or more parameter(s) could be RA-InformationCommon.

Additionally and/or alternatively, the one or more parameter(s) could be contentionDetected.

Additionally and/or alternatively, the one or more parameter(s) could be dlRSRPAboveThreshold.

Additionally and/or alternatively, the one or more parameter(s) could be fallbackToFourStepRA.

Additionally and/or alternatively, there could be (only) one entry in perRAInfoList if or when the random access procedure is on the non-serving cell.

Additionally and/or alternatively, the UE could include or append or store information associated with one non-serving cell in a random access information.

The UE could include or append or store information associated with one or more random access procedure(s) for random access procedure on the non-serving cell (in a same entry) in the random access information.

The information could include IE and/or parameter(s) in RA-Report and/or in ra-InformationCommon.

Additionally and/or alternatively, the UE could include or append or store information for each random access procedure(s) on a same non-serving cell in different random access information (or in different entries of the random access information).

The entry could be an entry in VarRA-Report or ra-ReportList.

For example, the UE could receive a first PDCCH order indicating a first random access preamble transmission to a non-serving cell. The UE could receive a second PDCCH order indicating a second random access preamble transmission to the non-serving cell (for early TA acquisition). The UE could include information of the first random access preamble transmission and information of the second random access preamble transmission in a same entry or in different entries in the random access information.

For the above and herein concepts and examples, the following aspects and embodiments are possible.

The random access information could be or could be included in ra-ReportList or RA-Report-r16 or VarRA-Report.

The UE could indicate/generate the random access information in response to a request from the network. The request could be successHO-ReportReq or mobilityHistoryReportReq or ra-ReportReq.

Random access procedures associated with a candidate cell could contain random access procedures for early TA acquisition and/or LTM random access procedure triggered by a network and/or LTM random access procedure initiated by the UE (based on a condition). (Part of) Random access procedures associated with the candidate cell could be provided/configured in a candidate configuration or LTM configuration associated with the candidate cell.

An LTM random access procedure to a candidate cell could be a random access procedure for switching the UE's SpCell/PCell to the candidate cell (associated with an LTM candidate configuration). An LTM random access procedure for a candidate cell could be associated with or in an LTM procedure to the candidate cell. An LTM random access procedure could be initiated by a network (e.g., via cell switch command) or initiated by the UE (e.g., via a condition).

A candidate cell could be a (Primary) cell in a candidate cell group configuration. A candidate cell could be a target cell in a (random access procedure of) LTM procedure or an early TA acquisition. The candidate cell may not be a Serving Cell.

The candidate cell group configuration could be an RRC reconfiguration message. The candidate cell group configuration could be a candidate configuration.

The candidate configuration may not contain IE reconfigurationWithSync. The UE may not perform or execute reconfiguration with sync in response to or during or for an LTM procedure (associated with the candidate configuration).

A UE could perform a TA acquisition indicated by the network or initiated by the UE (itself) (e.g., for a candidate cell). A TA acquisition could be an early TA acquisition for a candidate cell before receiving a cell switch command for an LTM procedure. The TA acquisition could contain a RAR-based RACH or a RAR-less RACH. The RAR could indicate TA information (e.g., TA or Tracking Area Code (TAC)) associated with the candidate cell. The (RAR-less) random access procedure to the candidate cell for early TA acquisition for the candidate cell could contain transmitting a random access preamble to the candidate cell (once). The (RAR-less) random access procedure to the candidate cell for early TA acquisition for the candidate cell may not contain the UE monitoring (PDCCH) (common) search space for receiving a random access response. The (RAR-less) random access procedure to the candidate cell for early TA acquisition for the candidate cell could contain (only) one random access preamble transmission to the candidate cell per PDCCH order reception for the candidate cell from the network. The PDCCH order could indicate the UE to initiate the (RAR-less) random access procedure to the candidate cell for early TA acquisition.

A RAR-less RACH could contain a random access response. The random access response may not contain a RAR. The RAR could be a MAC payload of a Random Access Response. The RAR-less RACH could contain a MAC subheader (only) of a Random Access Response.

The UE could be configured with RAR-less RACH for candidate cells. A RAR-less RACH could contain a RAR-less TA acquisition mechanism.

The UE could consider the random access procedure to the candidate cell for early TA acquisition successfully performed in response to (one) preamble transmission associated with the random access procedure.

A serving cell/candidate cell configuration could be/include a RACH configuration for random access procedure on a candidate cell. The RACH configuration could indicate search space id and/or RACH occasion and/or preamble index.

A TA information associated with a candidate cell could be a TA command (Timing advance command) or an N_{TA} or a TA Group (TAG) associated with the candidate cell.

TA information of a candidate cell could be a timing difference between an uplink and downlink associated with the candidate cell.

The PDCCH order initiating a random access procedure on a candidate cell could contain or indicate a Bandwidth Part (BWP) (of a candidate cell).

The PDCCH order initiating a random access procedure on a candidate cell could contain or indicate a Cell/candidate index (of a candidate cell or a candidate cell configuration).

The PDCCH order initiating a random access procedure on a candidate cell could contain or indicate a RACH configuration (associated with a candidate cell or a candidate cell configuration).

The first PDCCH occasion (at which the UE starts the window) could be a first PDCCH occasion associated with C-RNTI or RA-RNTI (after preamble transmission or after an offset after the preamble transmission). The first PDCCH occasion could be a first PDCCH occasion associated with a (Type-1) common search space or a UE-specific search space.

The LTM could be an intra-Distributed Unit (DU) LTM. Alternatively, the LTM could be an inter-DU or inter-Centralized (CU) LTM.

The LTM could comprise the network transmitting a first information and a second information to the UE. The first information could be an RRC message indicating one or more candidate cells (or cell group or one or more RRC reconfigurations indicating one or more candidate configurations). The one or more candidate configurations could contain or could be one or more RRC reconfigurations. The first information could contain one or more Cellgroupconfigs or one or more RRC reconfiguration messages. The second information could be a nL1 or L2 signaling and/or a (LTM) cell switch command (e.g., PDCCH and/or MAC CE). The UE could initiate an LTM random access procedure or start Cell switching (to one or more candidate cell(s)) in response to the second information (e.g., the cell switch command or the LTM cell switch MAC CE).

The first information could contain a RACH configuration and/or a Cell configuration for the one or more candidate cells. The network could indicate, in a PDCCH order for TA acquisition for candidate cells, the RACH configurations for corresponding candidate cells.

A candidate cell list could contain a list of candidate cell(s) (e.g., a list of candidate cell configuration(s) indicating a list of candidate cell(s)).

The candidate cell configuration could be an (part of) RRC reconfiguration message.

The RRC message could be a RRCReconfiguration.

The UE could consider the LTM to be successfully completed when receiving an acknowledgement from a network (e.g., target gNB). The acknowledgment could be in response to a complete message associated with the LTM transmitted by the UE. Additionally and/or alternatively, the UE could consider the LTM to be successfully completed when a random access procedure associated with (or initiated for the LTM) is successfully completed.

The UE could apply the stored TA associated with the candidate cell to the candidate cell during or at the beginning of an LTM procedure to the candidate cell.

Random access procedures associated with a non-serving cell could contain random access procedures for inter-Cell multi-TRP (mTRP) operation.

For a serving cell associated with a non-serving cell, the UE could perform inter-cell multi-TRP (mTRP) operation on the serving cell and the non-serving cell.

For a serving cell associated with a non-serving cell, configuration of the serving cell could include configuration of the non-serving cell. The configuration of the non-serving cell could be additionalPCI.

The serving cell could contain a list of non-serving cell(s) including at least the non-serving cell.

A non-serving cell could be replaced by additionalPCI.

Note that any of the above and herein methods, alternatives, concepts, examples, and embodiments may be combined, in whole or in part, or applied simultaneously or separately.

Exemplary embodiments of the present invention are described below.

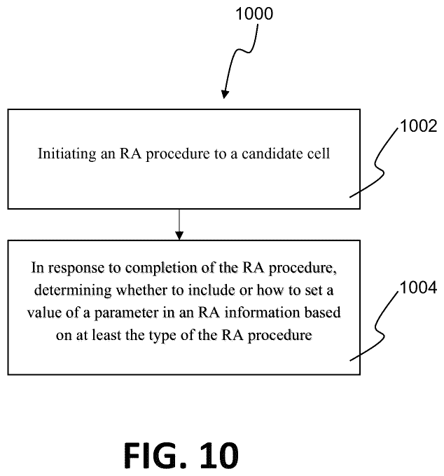

Referring to FIG. 10, with this and other concepts, systems, and methods of the present invention, a method 1000 of a UE comprises initiating an RA procedure to a candidate cell (step 1002), and in response to completion of the RA procedure, determining whether to include or how to set a value of a parameter in an RA information based on at least the type of the RA procedure (step 1004).

In various embodiments, the RA information is ra-ReportList or RA-Report-r16 or VarRA-Report.

In various embodiments, the type of the RA procedure is an early TA acquisition to the candidate cell.

In various embodiments, the UE does not include the parameter if or when the RA procedure is an early TA acquisition to the candidate cell.

In various embodiments, the UE sets the value of the parameter as ‘LTM-related’ if or when the RA procedure is an early TA acquisition to the candidate cell.

In various embodiments, the UE sets the value of the parameter as ‘accessRelated’ if or when the RA procedure is an early TA acquisition to the candidate cell.

In various embodiments, the UE sets the value of the parameter as ‘early-TA’ if or when the RA procedure is an early TA acquisition to the candidate cell

In various embodiments, the type of the RA procedure is an LTM RA procedure initiated by the network.

In various embodiments, the UE sets the value of the parameter as ‘LTM-related’ if or when the RA procedure is an LTM RA procedure initiated by the network.

In various embodiments, the UE sets the value of the parameter as ‘accessRelated’ if or when the RA procedure is an LTM RA procedure initiated by the network.

In various embodiments, the UE sets the value of the parameter as ‘NW-initiated-LTM’ if or when the RA procedure is an LTM RA procedure initiated by the network.

In various embodiments, the type of the RA procedure is an LTM RA procedure initiated by the UE (in response to a condition being met).

In various embodiments, the UE sets the value of the parameter as ‘LTM-related’ if or when the RA procedure is an LTM RA procedure initiated by the UE.

In various embodiments, the UE sets the value of the parameter as ‘accessRelated’ if or when the RA procedure is an LTM RA procedure initiated by the UE.

In various embodiments, the UE sets the value of the parameter as ‘UE-initiated-LTM’ if or when the RA procedure is an LTM RA procedure initiated by the UE.

In various embodiments, the candidate cell is configured in a candidate configuration.

In various embodiments, the network initiates the LTM RA procedure via an LTM cell switch command.

In various embodiments, the parameter is perRAInfoList.

In various embodiments, the parameter is raPurpose.

Referring back to FIGS. 3 and 4, in one or more embodiments from the perspective of a UE, the device 300 includes a program code 312 stored in memory 310 of the transmitter. The CPU 308 could execute program code 312 to: (i) initiate an RA procedure to a candidate cell; and (ii) in response to completion of the RA procedure, determine whether to include or how to set a value of a parameter in an RA information based on at least the type of the RA procedure. Moreover, the CPU 308 can execute the program code 312 to perform all of the described actions, steps, and methods described above, below, or otherwise herein.

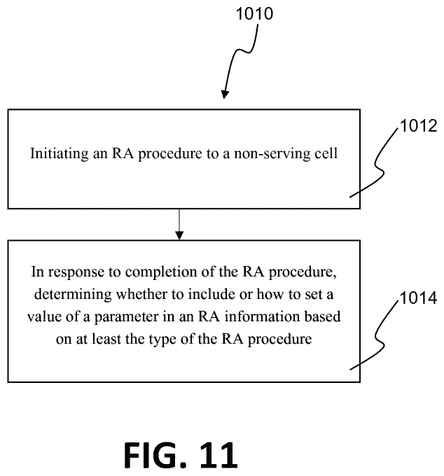

Referring to FIG. 11, with this and other concepts, systems, and methods of the present invention, a method 1010 of a UE comprises initiating a RA procedure to a non-serving cell (step 1012), and in response to completion of the RA procedure, determining whether to include or how to set a value of a parameter in an RA information based on at least the type of the RA procedure (step 1014).

In various embodiments, the RA information is ra-ReportList or RA-Report-r16 or VarRA-Report.

In various embodiments, the type of the RA procedure is a RA procedure on a non-serving cell.

In various embodiments, the UE does not include the parameter if or when the RA procedure is performed on a non-serving cell.

In various embodiments, the UE sets the value of the parameter as ‘inter-Cell mTRP related’ if or when the RA procedure is performed on a non-serving cell.

In various embodiments, the UE sets the value of the parameter as an additional PCI associated with a non-serving cell if or when the RA procedure is performed on the non-serving cell.

In various embodiments, the parameter is additionalPCI.

In various embodiments, the UE sets the value of the parameter as an index or an id of a serving cell if or when the RA procedure is performed on a non-serving cell associated with the serving cell.

In various embodiments, the UE sets the value of the parameter as an additional PCI associated with a non-serving cell if or when the RA procedure is performed on the non-serving cell.

In various embodiments, the parameter is cellId.

In various embodiments, the parameter is servingCellId.

In various embodiments, the parameter is SpCellID.

In various embodiments, the UE does not set the value of the parameter if or when the RA procedure is not performed on a non-serving cell.

In various embodiments, the parameter is perRAInfoList.

In various embodiments, the parameter is raPurpose.

Referring back to FIGS. 3 and 4, in one or more embodiments from the perspective of a UE, the device 300 includes a program code 312 stored in memory 310 of the transmitter. The CPU 308 could execute program code 312 to: (i) initiate an RA procedure to a non-serving cell; and (ii) in response to completion of the random access procedure, determine whether to include or how to set a value of a parameter in an RA information based on at least the type of the RA procedure. Moreover, the CPU 308 can execute the program code 312 to perform all of the described actions, steps, and methods described above, below, or otherwise herein.

Examples of text changes based on 38.331 are shown below:
option 1 start

### UEInformationResponse

| ... | | |
|---|---|---|
| RA-Report-r16 ::= | SEQUENCE { | |
| cellId-r16 | CHOICE { | |
| cellGlobalId-r16 | CGI-Info-Logging-r16, | |
| pci-arfcn-r16 | PCI-ARFCN-NR-r16 | |
| }, | | |
| ra-InformationCommon-r16 | RA-InformationCommon-r16 | OPTIONAL, |

| | |
|---|---|
| raPurpose-r16 | ENUMERATED {accessRelated, beamFailureRecovery, |
| reconfigurationWithSync, ulUnSynchronized, | |
| | schedulingRequestFailure, |
| noPUCCHResourceAvailable, requestForOtherSI, | |
| | msg3RequestForOtherSI-r17, LTMRelated, |
| spare7, spare6, spare5, spare4, spare3, | |
| | spare2, spare1}, |
| ..., | |

option 1 end
option 2 start

### UEInformationResponse

| ... | | |
|---|---|---|
| RA-Report-r16 | SEQUENCE { | |
| cellId-r16 | CHOICE { | |
| cellGlobalId-r16 | CGI-Info-Logging-r16, | |
| pci-arfcn-r16 | PCI-ARFCN-NR-r16 | |
| }, | | |
| ra-InformationCommon-r16 | RA-InformationCommon-r16 | OPTIONAL, |

| | |
|---|---|
| raPurpose-r16 | ENUMERATED {accessRelated, beamFailureRecovery, |

reconfigurationWithSync, ulUnSynchronized,

schedulingRequestFailure,

noPUCCHResourceAvailable, requestForOtherSI,

msg3RequestForOtherSI-r17, early TA

acquisition, NWtriggeredLTM, UEtriggeredLTM, spare5, spare4, spare3,

spare2, spare1},

option 2 end
option 3 start

RA-InformationCommon field descriptions
. . .

perRAInfoList, perRAInfoList-v1660
This field provides detailed information about each of the random access attempts in the chronological order of the
random access attempts. If perRAInfoList-v1660 is present, it shall contain the same number of entries, listed in the
same order as in perRAInfoList-r16. This field is not present if the random access procedure is for early TA acquisition
for a candidate cell.

option 3 end
option 4 start

### UEInformationResponse

| | | |
|---|---|---|
| ... | | |
| RA-Report-r16 ::= | SEQUENCE { | |
| cellId-r16 | CHOICE { | |
| cellGlobalId-r16 | CGI-Info-Logging-r16, | |
| pci-arfcn-r16 | PCI-ARFCN-NR-r16 | |
| }, | | |
| ra-InformationCommon-r16 | RA-InformationCommon-r16 | OPTIONAL, |

| | |
|---|---|
| raPurpose-r16 | ENUMERATED {accessRelated, beamFailureRecovery, |

reconfigurationWithSync, ulUnSynchronized,

schedulingRequestFailure,

noPUCCHResourceAvailable, requestForOtherSI,

| | msg3RequestForOtherSI-r17, inter-cell |
|---|---|
| multi-TA mTRP related , spare7, spare6, spare5, spare4, spare3, | |
| | spare2, spare1}, |
| ..., | |

option 4 end
option 5 start

### UEInformationResponse

| ... | | |
|---|---|---|
| RA-Report-r16 ::= | SEQUENCE { | |
| cellId-r16 | CHOICE { | |
| cellGlobalId-r16 | CGI-Info-Logging-r16, | |
| pci-arfcn-r16 | PCI-ARFCN-NR-r16 | |
| }, | | |
| ra-InformationCommon-r16 | RA-InformationCommon-r16 | OPTIONAL, |
| raPurpose-r16 | ENUMERATED {accessRelated, beamFailureRecovery, | |
| reconfigurationWithSync, ulUnSynchronized, | | |
| | schedulingRequestFailure, | |

noPUCCHResourceAvailable, requestForOtherSI,

| | msg3RequestForOtherSI-r17, spare8, spare7, | |
|---|---|---|
| spare6, spare5, spare4, spare3, | | |
| | spare2, spare1}, | |
| ..., | | |
| [[additionalPCI-r18 | PhysCellId | OPTIONAL |
| ]] | | |

RA-Report field descriptions

cellID
This field indicates the CGI of the cell in which the associated random access procedure was performed. This field
indicates the serving cell associated with a Cell with an additional PCI on which the UE performs the random
access procedure if the associated random access procedure is on the Cell associated with an additional PCI.
additionalPCI
PCI of the cell on which the UE performs the random access procedure.

option 5 end
option 6 start

| RA-Report-r16 ::= | SEQUENCE { | |
|---|---|---|
| cellId-r16 | CHOICE { | |
| cellGlobalId-r16 | CGI-Info-Logging-r16, | |
| pci-arfcn-r16 | PCI-ARFCN-NR-r16 | |
| }, | | |
| ra-InformationCommon-r16 | RA-InformationCommon-r16 | OPTIONAL, |
| raPurpose-r16 | ENUMERATED { accessRelated, beamFailureRecovery, | |
| reconfigurationWithSync, ulUnSynchronized, | | |
| | schedulingRequestFailure, | |
| noPUCCHResourceAvailable, requestForOtherSI, | | |
| | msg3RequestForOtherSI-r17, spare8, spare7, | |
| spare6, spare5, spare4, spare3, | | |
| | spare2, spare1}, | |
| ..., | | |
| [[ | | |
| spCellID-r17 | CGI-Info-Logging-r16 | |
| ]] | | |
| [[ | | |
| servingCellId-r18 | CHOICE { | |
| cellGlobalId-r16 | CGI-Info-Logging-r16, | |
| pci-arfcn-r16 | PCI-ARFCN-NR-r16 | |
| } OPTIONAL | | |
| ]] | | |
| } | | |

RA-Report field descriptions

cellID
This field indicates the CGI of the cell in which the associated random access procedure was performed. This field
indicates a Cell with additional PCI if the associated random access procedure is performed on the Cell.
servingCellId
This field indicates the Serving Cell associated with the additional PCI if the associated random access
procedure is performed on a Cell with the additional PCI.

option 6 end
option 7 start

| | | |
|---|---|---|
| RA-InformationCommon-r16 ::= | SEQUENCE { | |
| absoluteFrequencyPointA-r16 | ARFCN-ValueNR, | |
| ... | | |
| [[additionalPCI-r18 | PhysCellId | OPTIONAL |
| ]] | | |
| } | | |

RA-InformationCommon field descriptions

additionalPCI
PCI of the cell of the SSB or CSI-RS on which the UE performs the random access procedure.

option 7 end
option 8 start

| | | |
|---|---|---|
| RA-Report-r16 ::= | SEQUENCE { | |
| cellId-r16 | CHOICE { | |
| cellGlobalId-r16 | CGI-Info-Logging-r16, | |
| pci-arfcn-r16 | PCI-ARFCN-NR-r16 | |
| }, | | |
| ra-InformationCommon-r16 | RA-InformationCommon-r16 | OPTIONAL, |

| | |
|---|---|
| raPurpose-r16 | ENUMERATED {accessRelated, beamFailureRecovery, |

reconfigurationWithSync, ulUnSynchronized,

schedulingRequestFailure,

noPUCCHResourceAvailable, requestForOtherSI,
spare6, spare5, spare4, spare3,

| | | |
|---|---|---|
| | spare2, spare1}, | |
| ..., | | |
| [[ | | |
| spCellID-r17 | CGI-Info-Logging-r16 | OPTIONAL |
| ]] | | |
| [[ | | |
| servingCellId-r18 | CGI-Info-Logging-r16 | OPTIONAL |
| ]] | | |
| } | | |

RA-Report field descriptions

cellID
This field indicates the CGI of the cell in which the associated random access procedure was performed. This field
indicates a Cell with additional PCI if the associated random access procedure is performed on the Cell.
servingCellId
This field indicates the Serving Cell associated with the additional PCI if the associated random access
procedure is performed on a Cell with the additional PCI.

option 8 end

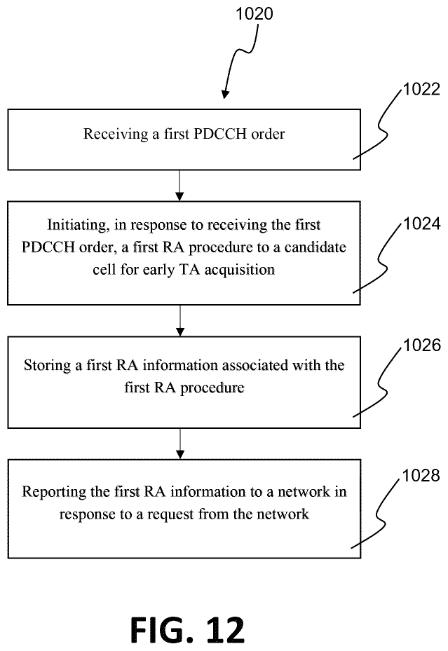

Referring to FIG. 12, with this and other concepts, systems, and methods of the present invention, a method 1020 of a UE comprises receiving a first PDCCH order (step 1022), initiating, in response to receiving the first PDCCH order, a first RA procedure to a candidate cell for early TA acquisition (step 1024), storing a first RA information associated with the first RA procedure (step 1026), and reporting the first RA information to a network in response to a request from the network (step 1028).

In various embodiments, a purpose of the first RA information is set to a first purpose or a second purpose.

In various embodiments, the first purpose is ‘early TA acquisition’, early-TA’, or ‘LTMRelated’.

In various embodiments, the second purpose is ‘ulUnSynchronized’.

In various embodiments, the method further comprises receiving a second PDCCH order, and initiating a second RA procedure to a serving cell in response to receiving the second PDCCH order, and storing a second RA information associated with the second RA procedure, wherein a purpose of the second RA information is set to the second purpose.

In various embodiments, the method further comprises receiving an LTM cell switch command, and initiating a third RA procedure to the candidate cell in response to receiving the LTM cell switch command, and storing a third RA information associated with the third RA procedure, wherein a purpose of the third RA information is set to the first purpose.

In various embodiments, the UE indicates an identity of an SpCell in the first RA information.

In various embodiments, the identity of the SpCell is an identity of a PCell if or when the candidate cell is configured in a candidate configuration associated with a MCG, and/or the identity of the SpCell is an identity of a PSCell if or when the candidate cell is configured in a candidate configuration associated with an SCG.

In various embodiments, the method further comprises receiving a third PDCCH order, and initiating a fourth RA procedure to the candidate cell for early TA acquisition in response to receiving the third PDCCH order, wherein the first RA information includes information of a second RA preamble transmission of the fourth RA procedure.

In various embodiments, information of a first RA preamble transmission of the first RA procedure and information of a second RA preamble transmission of a fourth RA procedure to the candidate cell for early TA acquisition are indicated or stored by a same RA-Report.

In various embodiments, the first RA information is included in an RA-Report or is the RA-Report.

In various embodiments, the first RA procedure is RAR-less.

In various embodiments, the first RA information includes information of a first RA preamble transmission of the first RA procedure and/or includes ra-InformationCommon.

In various embodiments, the request is successHO-ReportReq or ra-ReportReq.

Referring back to FIGS. 3 and 4, in one or more embodiments from the perspective of a UE, the device 300 includes a program code 312 stored in memory 310 of the transmitter. The CPU 308 could execute program code 312 to: (i) receive a first PDCCH order; (ii) initiate, in response to receiving the first PDCCH order, a first RA procedure to a candidate cell for early TA acquisition; (iii) store a first RA information associated with the first RA procedure; and (iv) report the first RA information to a network in response to a request from the network. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials. While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a first Physical Downlink Control Channel (PDCCH) order;
initiating, in response to receiving the first PDCCH order, a first Random Access (RA) procedure to a candidate cell for early Timing Advance (TA) acquisition;
storing a first RA information associated with the first RA procedure; and
reporting the first RA information to a network in response to a request from the network.

2. The method of claim 1, wherein a purpose of the first RA information is set to a first purpose or a second purpose.

3. The method of claim 2, wherein the first purpose is ‘early TA acquisition’, ‘early-TA’, or ‘LTMRelated’.

4. The method of claim 2, wherein the second purpose is ‘ulUnSynchronized’.

5. The method of claim 2, further comprising:
receiving a second PDCCH order, and initiating a second RA procedure to a serving cell in response to receiving the second PDCCH order; and
storing a second RA information associated with the second RA procedure, wherein a purpose of the second RA information is set to the second purpose.

6. The method of claim 2, further comprising:
receiving an L1/L2-triggered Mobility (LTM) cell switch command, and initiating a third RA procedure to the candidate cell in response to receiving the LTM cell switch command; and
storing a third RA information associated with the third RA procedure, wherein a purpose of the third RA information is set to the first purpose.

7. The method of claim 1, wherein the UE indicates an identity of a Special Cell (SpCell) in the first RA information.

8. The method of claim 7, wherein the identity of the SpCell is an identity of a Primary Cell (PCell) if or when the candidate cell is configured in a candidate configuration associated with a Master Cell Group (MCG), and/or the identity of the SpCell is an identity of a Primary Secondary Cell (PSCell) if or when the candidate cell is configured in a candidate configuration associated with a Secondary Cell Group (SCG).

9. The method of claim 1, further comprising:
receiving a third PDCCH order, and initiating a fourth RA procedure to the candidate cell for early TA acquisition in response to receiving the third PDCCH order, wherein the first RA information includes information of a second RA preamble transmission of the fourth RA procedure.

10. The method of claim 1, wherein information of a first RA preamble transmission of the first RA procedure and information of a second RA preamble transmission of a fourth RA procedure to the candidate cell for early TA acquisition are indicated or stored by a same RA-Report.

11. The method of claim 1, wherein the first RA information is included in an RA-Report or is the RA-Report.

12. The method of claim 1, wherein the first RA procedure is Random Access Response (RAR)-less.

13. The method of claim 1, wherein the first RA information includes information of a first RA preamble transmission of the first RA procedure and/or includes ra-InformationCommon.

14. The method of claim 1, wherein the request is successHO-ReportReq or ra-ReportReq.

15. A User Equipment (UE), comprising:
a memory; and
a processor operatively coupled with the memory, wherein the processor is configured to execute a program code to:
receive a first Physical Downlink Control Channel (PDCCH) order;
initiate, in response to receiving the first PDCCH order, a first Random Access (RA) procedure to a candidate cell for early Timing Advance (TA) acquisition;
store a first RA information associated with the first RA procedure; and
report the first RA information to a network in response to a request from the network.

16. The UE of claim 15, wherein a purpose of the first RA information is set to a first purpose or a second purpose.

17. The UE of claim 16, wherein the first purpose is ‘early TA acquisition’, ‘early-TA’, or ‘LTMRelated’.

18. The UE of claim 16, wherein the second purpose is ‘ulUnSynchronized’.

19. The UE of claim 15, wherein the UE indicates an identity of a Special Cell (SpCell) in the first RA information.

20. The UE of claim 15, wherein information of a first RA preamble transmission of the first RA procedure and information of a second RA preamble transmission of a fourth RA procedure to the candidate cell for early TA acquisition are indicated or stored by a same RA-Report.
